(19) United States
(12) Patent Application Publication
(10) Pub. No.: US 2014/0112546 A1
(43) Pub. Date: Apr. 24, 2014

(54) Video Surveillance System

(71) Applicant: Panasonic Corporation, Osaka (JP)

(72) Inventors: Kuo Chu Lee, Princeton Junction, NJ (US); Hasan Timucin Ozdemir, Plainsboro, NJ (US); Xiangjun Shi, Plainsboro, NJ (US); Lipin Liu, Belle Mead, NJ (US); Namsoo Joo, East Brunswick, NJ (US); Juan Yu, Cranbury, NJ (US); Jun Liu, Ewing, NJ (US)

(73) Assignee: Panasonic Corporation, Osaka (JP)

(21) Appl. No.: 14/139,266

(22) Filed: Dec. 23, 2013

Related U.S. Application Data
(62) Division of application No. 12/709,192, filed on Feb. 19, 2010.

(51) Int. Cl. G06T 7/20; G06K 9/00

(52) U.S. Cl. CPC G06T 7/2086; G06K 9/00771
USPC 382/107

(57) ABSTRACT

A video surveillance system is disclosed. The system includes a model database storing a plurality of models and a vector database storing a plurality of vectors of recently observed trajectories. The system includes a model building module that builds a new motion model corresponding to the motion data of the current trajectory data structure. The system generates a current trajectory data structure having motion data and abnormality scores. The system also includes a database purging module configured to determine a subset of vectors that is most similar to the current trajectory data structure based on a measure of similarity between the subset of vectors and the current trajectory data structure. The database purging module is further configured to replace one of the motion models in the model database with the new motion model based on an amount of vectors in the subset vectors the recentness of the subset of vectors.

### FIELD

The present disclosure relates to a video surveillance system that adaptively updates models used to determine the existence of abnormal behavior detection.

### BACKGROUND

More so than ever, security issues are rising to the level of national attention. In order to ensure the safety of people and property, monitoring at risk areas or spaces is of utmost importance. Traditionally, security personnel may monitor a space. For example, at an airport a security official may monitor the security check point, which is generally set up to allow people to exit the gate area from an exit and enter the gate area through the metal detectors and luggage scanners. As can be imagined, if the security guard temporarily stops paying attention to the exit, a security threat may enter the gate area through the exit. Once realized, this may cause huge delays as airport security personnel try to locate the security threat. Furthermore, each space to be monitored must be monitored by at least one security guard, which increases the costs of security.

The other means of monitoring a space is to have a single camera or a plurality of video cameras monitoring the space or a plurality of spaces and have security personnel monitor the video feeds. This method, however, also introduces the problem of human error, as the security personnel may be distracted while watching the video feeds or may ignore a relevant video feed while observing a non-relevant video feed.

As video surveillance systems are becoming more automated, however, spaces are now being monitored using predefined motion models. For instance, a security consultant may define and hard code trajectories that are labeled as normal, and observed motion may be compared to the hard coded trajectories to determine if the observed motion is abnormal. This approach, however, requires static definitions of normal behavior. Thus, there is a need in the automated video surveillance system arts for an automated and/or adaptive means of defining motion models and detecting abnormal behavior.

This section provides background information related to the present disclosure which is not necessarily prior art.

### SUMMARY

In one aspect, a video surveillance system having a video camera that generates image data corresponding to a field of view of the video camera is disclosed. The system comprises a model database storing a plurality of motion models defining motion of a previously observed object. The system also includes a current trajectory data structure having motion data and at least one abnormality score, the motion data defining a spatio-temporal trajectory of a current object observed moving in the field of view of the video camera and the abnormality score indicating a degree of abnormality of the current trajectory data structure in relation to the plurality of motion models. The system further comprises a vector database storing a plurality of vectors of recently observed trajectories, each vector corresponding to motion of an object recently observed by the camera and a model building module that builds a new motion model corresponding to the motion data of the current trajectory data structure. The system also includes a database purging module configured to receive the current trajectory data structure and determine a subset of vectors from the plurality of vectors in the vector database that is most similar to the feature the current trajectory data structure based on a measure of similarity between the subset of vectors and the current trajectory data structure. Additionally, the database purging module further configured to replace one of the motion models in the model data base with the new motion model based on an amount of vectors in the subset vectors and an amount of time since the recently observed trajectories of the subset of vectors were observed.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a block diagram illustrating an exemplary video surveillance system;

FIG. 2 is a block diagram illustrating exemplary components of the surveillance system;

FIG. 3A is a drawing illustrating an exemplary field of view (FOV) of a video camera;

FIG. 3B is a drawing illustrating an exemplary FOV of a camera with a gird overlaid upon the FOV.

FIG. 4 is a drawing of an exemplary trajectory vector;

FIG. 5 is a flow diagram illustrating an exemplary method for scoring a trajectory;

FIG. 6 is a block diagram illustrating exemplary components of the metadata processing module;

FIG. 7 is a drawing illustrating a data cell broken up into direction octants;

FIG. 8 is a block diagram illustrating exemplary components of the abnormal behavior detection module;

FIG. 9 is a drawing illustrating an exemplary embodiment of the dynamic model database and the feature vector database;

FIG. 10 is a block diagram illustrating exemplary components of the database purging module;

FIG. 11 is a drawing illustrating an exemplary Haar transform;

FIG. 12 is a flow diagram illustrating an exemplary method for matching a feature vector of a trajectory;

FIG. 13 is a block diagram illustrating exemplary components of an alternative embodiment of the metadata processing module;

FIG. 14 is a flow diagram illustrating an exemplary method for determining a the existence of an outlier;

FIG. 15 is a flow diagram illustrating an exemplary method for determining the existence of an outlier in the bounding box size;

FIG. 16 is a flow diagram illustrating an exemplary method for determining the existence of an outlier in an observed velocity;

FIG. 17 is a flow diagram illustrating an exemplary method for determining the existence of an outlier in an observed acceleration;

FIG. 18 is a state diagram illustrating a method for performing outlier confirmation;

FIG. 19 is a block diagram illustrating the exemplary components of a Haar filter;

FIGS. 20A-20C are graphs illustrating various means to increment and decrement a count of an octant of a cell; and

FIG. 21 is a drawing showing a partial Haar transform used to perform coefficient smoothing.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

An embodiment of the automated video surveillance system is herein described. The system receives a video stream, or image data, and detects an object that is observed moving in the field of view (FOV) of the camera, hereinafter referred to as a motion object. The image data is processed and the locations of the motion object is analyzed. A trajectory of the motion object is generated based on the analysis of the motion object. The trajectory of the motion object is then scored using at least one scoring engine and may be scored by hierarchical scoring engines. The scoring engines score the observed trajectory using normal behavior models as a reference. Based on the results of the scoring engines, abnormal behavior may be detected.

The normal behavior models define trajectories or a motion pattern of an object corresponding to expected or accepted behavior, or behavior that may not ordinarily rise to the level of an alarm event. For example, in a situation where a parking garage entrance is being monitored, a vehicle stopping at the gate for a short period of time and then moving forward into the parking area at a slow speed would be considered “normal” behavior.

As can be appreciated, however, in certain spaces what is considered normal behavior may change multiple times during the day. Furthermore, special events may occur where certain trajectories may be unexpected, yet may still be normal. For example, in a situation where a door in a school building is being monitored. Ordinarily, during class periods, an observed trajectory of an object, e.g. a student, exiting the building may be classified as abnormal. If, however, at that particular time the student's class was going outside for a special lesson, then the student's trajectory was actually normal. As more students are observed exiting the building, the system can learn this trajectory and subsequently store a new normal motion model corresponding to the trajectory. As the incident was a special occasion, however, the new normal motion model should be purged from the system, as such trajectories would no longer be normal. This new normal motion model will be replaced by a newer motion model corresponding to more recently observed trajectories. As can be appreciated, the system gauges what is “normal” behavior based on an amount of similar trajectories observed and the recentness of the similar trajectories. Once an indicator of at least one of the recentness and the amount of the similar trajectories to the normal motion model, or a function thereof, falls below a threshold or the indicator of another set of observed trajectories, the particular normal motion model can be purged or faded from the system. As can be appreciated, this allows for not only accurate detection of abnormal behavior but may also minimize the amount of storage that the system requires.

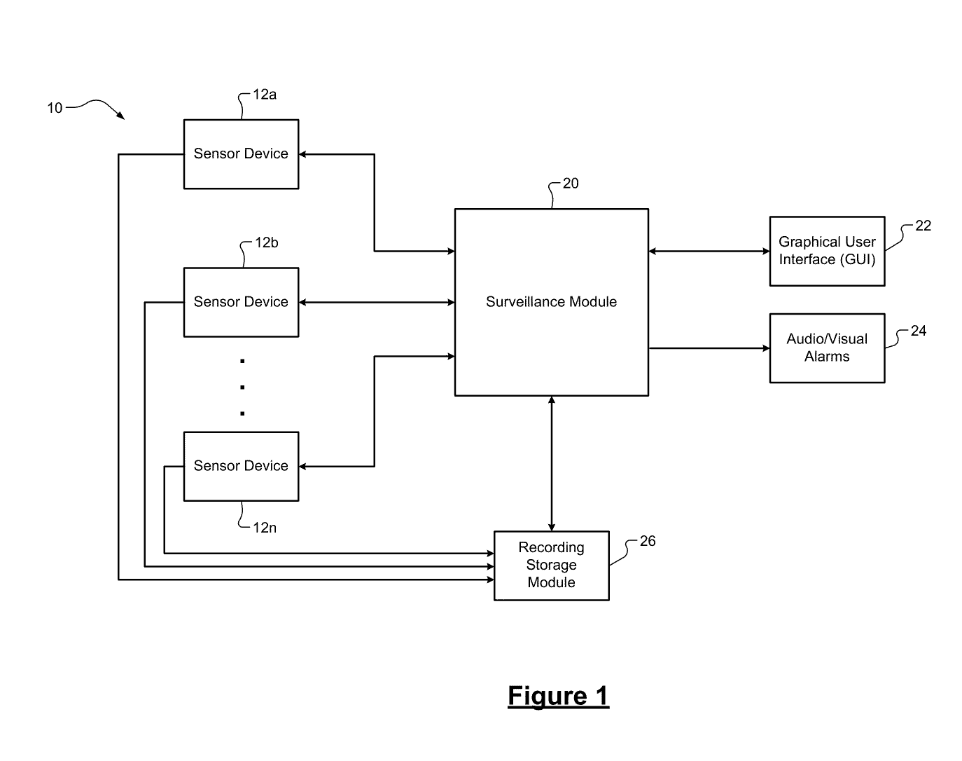

Referring to FIG. 1, an exemplary automated video surveillance system 10 is shown. The system may include sensing devices, e.g. video cameras 12a-12n, and a surveillance module 20. It is appreciated that the sensing devices may be other types of surveillance cameras such as infrared cameras or the like. For purposes of explanation, the sensing devices will be herein referred to as video cameras. Further, references to a single camera 12a may be extended to cameras 12b-12n. Video cameras 12a-12n monitor a space and generate image data relating to the field of view (FOV) of the camera and objects observed within the FOV and communicate the image data to surveillance module 20. The surveillance module 20 can be configured to process the image data to determine if a motion event has occurred. A motion event is when a motion object is observed in the FOV of the camera 12a. Once a motion object is detected, an observed trajectory corresponding to the motion of the trajectory of the motion object may be generated by the surveillance module 20. The surveillance module 20 may then score the trajectory using at least one scoring engine, which uses normal motion models as reference. If the observed trajectory is determined to be abnormal, then an alarm notification may be generated. The features of the observed trajectory, including score or scores corresponding to the observed trajectory, are then compared to features of other recently observed trajectories. If a relatively large number of recently observed trajectories are similarly scored, then the surveillance module 20 updates the normal motion models to include a new normal motion model corresponding to the recently observed trajectories. The surveillance module 20 can also manage a video retention policy, whereby the surveillance module 20 decides which videos should be stored and which videos should be purged from the system.

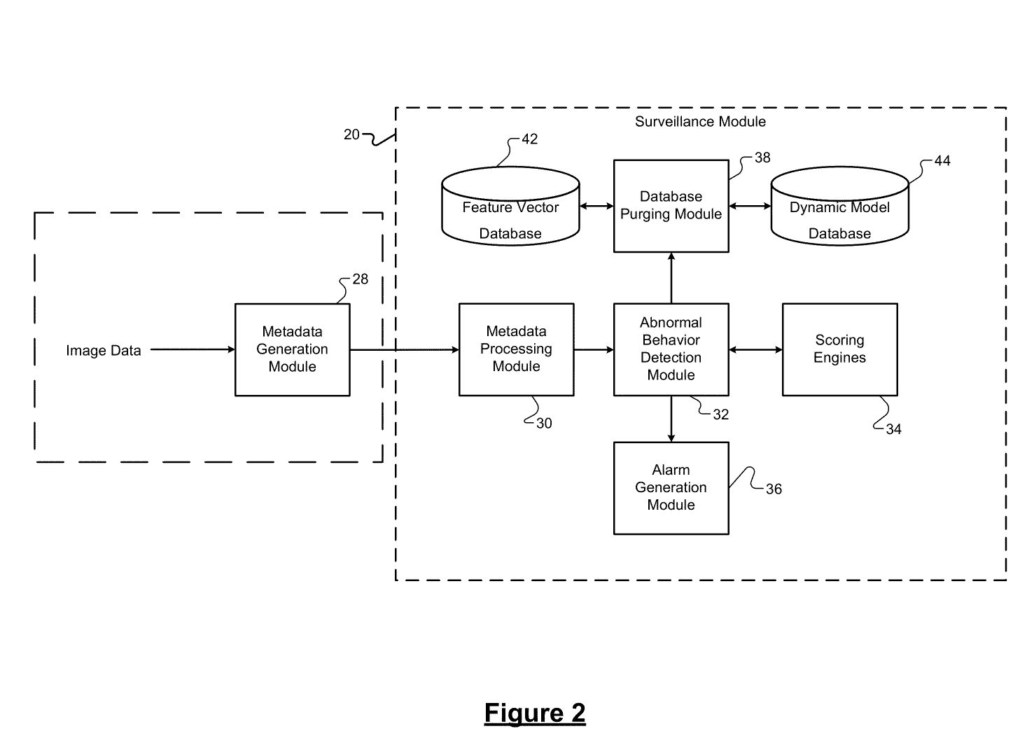

FIG. 2 illustrates exemplary components of the surveillance module 20 in greater detail. A video camera 12 generates image data corresponding to the captured video. An exemplary video camera 12 includes a metadata generation module 28 that generates metadata corresponding to the image data. It is envisioned that the metadata generation module 28 may be alternatively included in the surveillance module 20. The metadata processing module 30 receives the metadata and determines the observed trajectory of the motion object. It is appreciated that more than one motion object can be observed in the FOV of the camera and, thus, a plurality of observed trajectories may be generated by metadata processing module 30.

The observed trajectory is received by the abnormal behavior detection module 32. The abnormal behavior detection module 32 then communicates the trajectory to one or more scoring engines 34. The scoring engines 34 retrieve normal motion models from the dynamic model database 44 and score the observed trajectory relative to the normal motion models. In some embodiments the scoring engines are hierarchical, as will be discussed later. The individual scoring engines 34 return the scores to the abnormal behavior detection module 32. The abnormal behavior detection module 32 then analyzes the scores to determine if abnormal behavior has been observed. If so, an alarm event may be communicated to the alarm generation module 36. Further, the observed trajectory, normal or abnormal, is communicated to a database purging module 38.

Database updating module 38 adaptively learns and analyzes recently observed trajectories to determine if a change in the motion patterns of the motion objects, e.g. the general direction of motion objects, has occurred. If so, the database updating module 38 generates a normal motion model corresponding to the new flow pattern and stores the new normal motion model in the dynamic model database 44. Further, if trajectories corresponding to a normal motion model are no longer being observed, database updating module 38 purges the model from the dynamic model database 40.

It is envisioned that the surveillance module 20 can be embodied as computer readable instructions embedded in a computer readable medium, such as RAM, ROM, a CD-ROM, a hard disk drive or the like. Further, the instructions are executable by a processor associated with the video surveillance system. Further, some of the components or subcomponents of the surveillance module may be embodied as special purpose hardware.

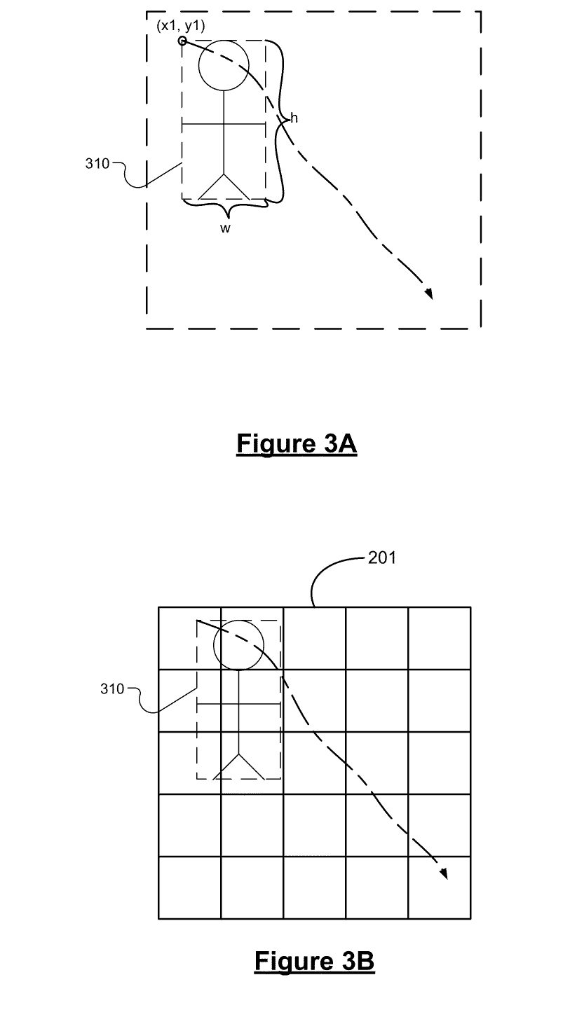

Metadata generation module 28 receives image data and generates metadata corresponding to the image data. Examples of metadata can include but are not limited to: a motion object identifier, a bounding box around the motion object, the (x,y) coordinates of a particular point on the bounding box, e.g. the top left corner or center point, the height and width of the bounding box, and a frame number or time stamp. FIG. 3A depicts an example of a bounding box 310 in a FOV of the camera. As can be seen, the top left corner is used as the reference point or location of the bounding box. Also shown in the figure are examples of metadata that can be extracted, including the (x,y) coordinates, the height and width of the bounding box 310. Furthermore, the FOV may be divided into a plurality of cells. FIG. 3B depicts an exemplary FOV divided into a 5×5 grid, i.e. 25 cells. For reference, the bounding box and the motion object are also depicted. When the FOV is divided into a grid, the location of the motion object can be referenced by the cell at which a particular point on the motion object or bounding box is located. Furthermore, the metadata for a time-series of a particular cell or region of the camera can be formatted into a data cube. Additionally, each cell's data cube may contain statistics about observed motion and appearance samples which are obtained from motion objects when they pass through these cells.

As can be appreciated, each time a motion event has been detected, a time stamp or frame number can be used to temporally sequence the motion object features. At each event, metadata may be generated for the particular frame or timestamp. For example, the following may represent the metadata corresponding to a motion object, where the time-stamped metadata is formatted according to the following <t, x, y, h, w, obj_id>:
<t₁, 5, 5, 4, 2, 1>, <t₂, 4, 4, 4, 2, 1>, . . . <t₅, 1, 1, 4, 2, 1>

As can be seen, the motion object having an id tag of 1, whose bounding box is four units tall and two units wide, moved from point (5,5) to point (1,1) in five samples. As can be seen, a motion object is defined by a set of spatio-temporal coordinates. It is also appreciated that any means of generating metadata from image data now known or later developed may be used by metadata generation module 28 to generate metadata.

The metadata generation module 28 communicates the metadata to the metadata processing module 30. The metadata processing module 30 generates a trajectory vector for a motion object from the metadata. For example, the metadata processing module 30 may receive a plurality of data cubes relating to a particular motion object. From the time stamped or otherwise sequenced metadata, the metadata processing module 30 can create a vector representing the motion of the motion object. The vector representing the trajectory may include, but is not limited to, the location of the bounding box at particular times, the velocity of the motion object, the acceleration of the motion object, and may have fields for various scores of the trajectory at the particular point in time.

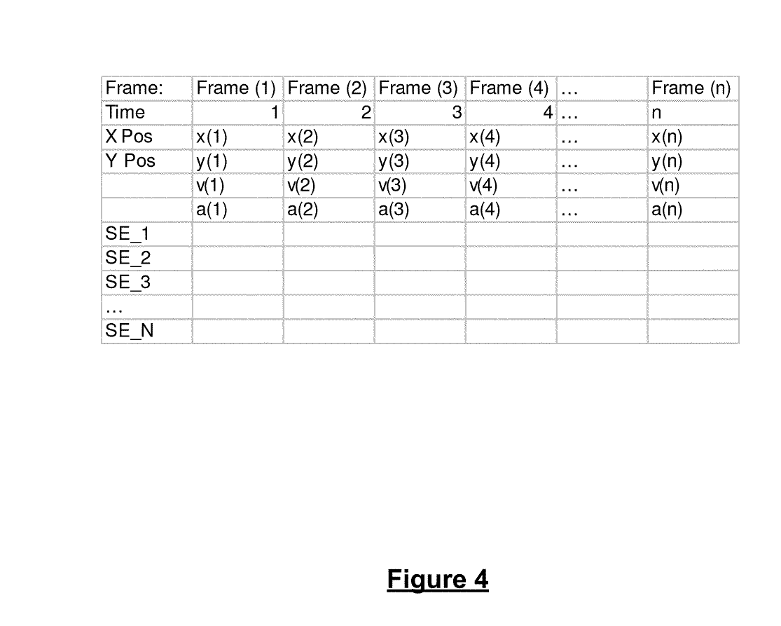

FIG. 4 illustrates an exemplary vector representation of a trajectory. As can be seen from the vector, the trajectory of the motion object can be easily passed to the scoring engines 34 and when the trajectory is scored, the fields designated by an SE are set to the corresponding score, thereby indicating a degree of abnormality. While a vector representing the trajectory is disclosed, it is appreciated that other types of data structures may be used to represent the trajectory.

Metadata processing module 30 can also be configured to remove outliers from the metadata. For example if received metadata is inconsistent with the remaining metadata then the metadata processing module 30 determines that the received metadata is an outlier and marks in the trajectory data.

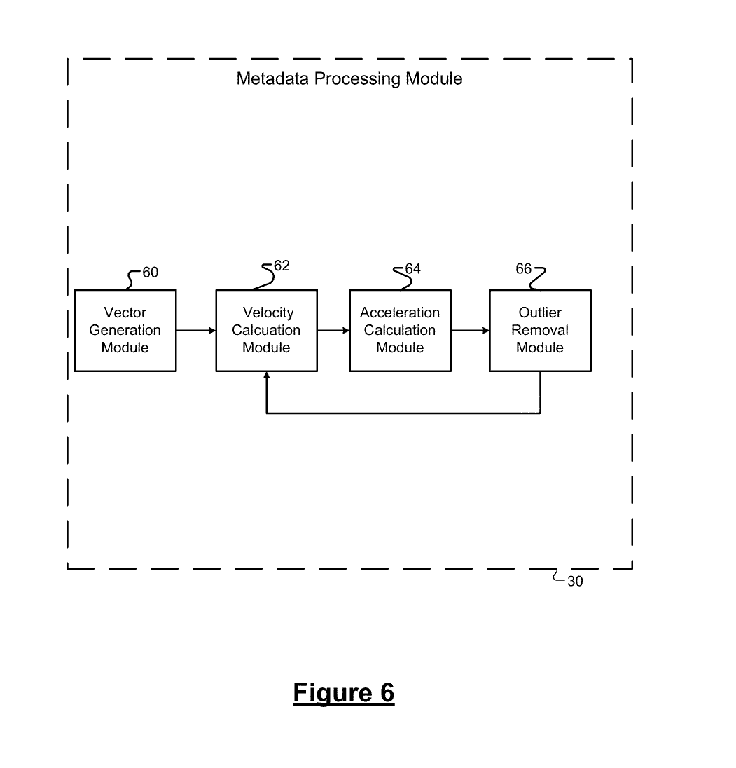

FIG. 6 illustrates components of an exemplary embodiment of the metadata processing module 30. Metadata processing module 30 receives the metadata from the metadata generation module 28. Vector generation module 60 receives the metadata and determines the amount of vectors to be generated. For example, if two objects are moving in a single scene, then two vectors may be generated. Vector generation module 60 can have a vector buffer that stores up to predetermined amount of trajectory vectors. Furthermore, vector generation module 60 can allocate the appropriate amount of memory for each vector corresponding to a motion object, as the amount of entries in the vector will equal the amount of frames or time stamped frames having the motion object observed therein. In the event vector generation is performed in real time, the vector generation module can allocate additional memory for the new points in the trajectory as the new metadata is received. Vector generation module 60 also inserts the position data and time data into the trajectory vector. The position data is determined from the metadata data cubes. The position data can be listed in actual (x,y) coordinates or by identifying the cell that the motion object was observed in.

Velocity calculation module 62 calculates the velocity of the trajectory at the various time samples. It is appreciated that the velocity at each time section will have two components, a direction and magnitude of the velocity vector. The magnitude relates to the speed of the motion object. The magnitude of the velocity vector, or speed of the motion object, can be calculated for the trajectory at t_{curr} by:

$$V ( {t}_{curr} ) = \frac{\sqrt{( {( x ( {t}_{curr} ) - x ( {t}_{cuur - 1} ) )}^{2} + ( {( y ( {t}_{cuur} ) - y ( {t}_{cuur - 1} ) )}^{2}}}{( {t}_{cuur} - {t}_{cuur - 1} )} \qquad ( 1 )$$

Alternatively, the magnitude of the velocity vector may be represented in its individual components, that is:

$$Vx ( {t}_{curr} ) = \frac{( ( x ( {t}_{cuur} ) - x ( {t}_{cuur - 1} ) )}{( {t}_{cuur} - {t}_{cuur - 1} )} and Vy ( {t}_{curr} ) = \frac{( ( y ( {t}_{cuur} ) - y ( {t}_{cuur - 1} ) )}{( {t}_{cuur} - {t}_{cuur - 1} )} \qquad ( 2 )$$

It is further appreciated that if data cell representation is used, that is the position of motion object is defined by the data cell which it is found in, a predetermined (x,y) value that corresponds to the data cell may be substituted for the actual location. It is appreciated that the calculated velocity will be relative to the FOV of the camera, e.g. pixels per second. Thus, objects further away will appear slower than objects closer to the camera, despite the fact that the two objects may be traveling at the same or similar speeds. While it is envisioned that the relative speed may be used, a conversion may be made so that the speed is the actual speed of the object or an approximation thereof. For example, motion objects at the bottom of the FOV can be scaled by a first lesser scalar, motion objects in the middle of the FOV can be scaled by a second intermediate scalar, and objects near the top of the FOV can be scaled by a third larger scalar. In this example, it is assumed that the objects at the bottom of the FOV are closer than those in the middle of the FOV, which are closer than those near the top of the FOV. It is further envisioned that other means of calculating the relative or actual velocity may be implemented.

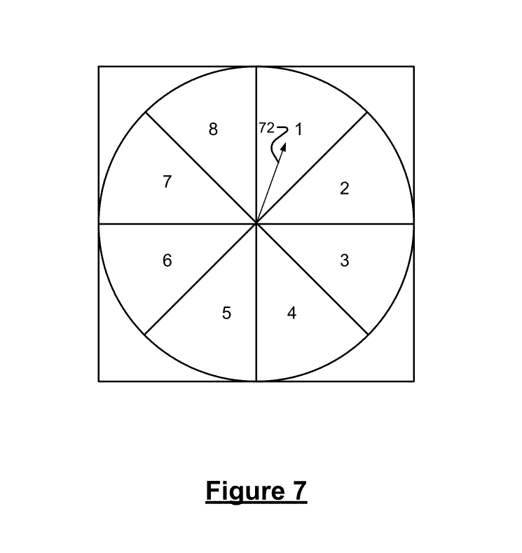

The direction of the velocity vector can be represented relative to its direction in a data cell by dividing each data cell into predetermined sub cells, e.g. 8 octants. FIG. 7 illustrates an example of a data cell 70 broken into 8 octants 1-8. Depending on the direction of the trajectory between the t_{curr} and t_{curr+1} samples, the direction may be approximated by determining which octant the trajectory could fall into. For example, a trajectory traveling in any direction near NNE, e.g. in a substantially upward direction and slightly to the right, can be given a single trajectory, as shown by reference 72. Thus, any velocity vector for a data cell may be represented by the data cell octant identifier and magnitude.

The acceleration calculation module 64 operates in substantially the same manner as the velocity calculation module. Instead of the position values, the magnitude of the velocity vectors at the various time samples may be used. Thus, the acceleration may be calculated by:

$$A ( {t}_{curr} ) = \frac{\sqrt{( {( Vx ( {t}_{cuur} ) - Vx ( {t}_{cuur - 1} ) )}^{2} + ( {( Vy ( {t}_{cuur} ) - Vy ( {t}_{cuur - 1} ) )}^{2}}}{( {t}_{cuur} - {t}_{cuur - 1} )} \qquad ( 3 )$$

Alternatively, the magnitude of the acceleration vector may be represented in its individual components, that is:

$$Ax ( {t}_{curr} ) = \frac{( ( Vx ( {t}_{cuur} ) - Vx ( {t}_{cuur - 1} ) )}{( {t}_{cuur} - {t}_{cuur - 1} )} and Ay ( {t}_{curr} ) = \frac{( ( Vy ( {t}_{cuur} ) - Vy ( {t}_{cuur - 1} ) )}{( {t}_{cuur} - {t}_{cuur - 1} )} \qquad ( 4 )$$

With respect to the direction, the direction of the acceleration vector may be in the same direction as the velocity vector. It is understood, however, that if the motion object is decelerating or turning, then the direction of the acceleration vector will be different than that of the velocity vector.

The outlier detection module 66 receives the trajectory vector and reads the values of the motion object at the various time samplings. An outlier is a data sample that is inconsistent with the remainder of the data set. For example, if a motion object is detected at the top left corner of the FOV in samples t1 and t3, but is located in the bottom right corner in sample t2, then the outlier detection module 66 can determine that the time sample for time t2 is an outlier. It is envisioned that any means of detecting outliers may be implemented in outlier detection module 66. Further, if an outlier is detected, outlier detection module may interpolate the position of the motion object based on the other data samples. This can be done, for example, by averaging the locations at the data point directly preceding and directly following the outlier data point. Other means of interpolating the data may be used as well. For example, the accelerations and the velocities of the preceding and following data points may be used in the interpolation to result in a more accurate location estimation.

It is noted that the metadata processing module 30 may calculate the velocities and accelerations of the motion object by other means, including a Haar filter, discussed below. Additionally, the trajectory vector can also be scored in real time, as is discussed below. In these embodiments, as a motion event occurs, the metadata processing module 30 determines the current data and passes the updated trajectory vector to the abnormal behavior detection module 32.

The metadata processing module 30 can be further configured to generate data cubes for each cell. A data cube is a multidimensional array where each element in the array corresponds to a different time. Each entry motion data observed in the particular cell at the corresponding time. Thus, in the data cube of a cell, the velocities and accelerations of various motion objects observed over time may be recorded. Further, the data cube may contain expected attributes of motion objects, such as the size of the minimum bounding box.

The observed trajectory vector corresponding to the motion object observed in the image data is then communicated to the abnormal behavior detection module 32. Abnormal behavior detection module 32 receives the observed trajectory vector and communicates the trajectory vector to one or more scoring engines. The scoring engines return abnormality scores for the trajectory. The abnormality scores can correspond to particular events in the trajectory vector, e.g. for each time stamp in the trajectory vector an abnormality score corresponding to the motion of the motion object up until that time may be returned. For example, for each time stamp, the trajectory vector up to the particular time stamp is scored by the various scoring engines. Thus, if a trajectory vector started off as being scored as a normal trajectory, the scores would be relatively low until the motion of the object deviates from the normal motion models, at which point the abnormality score would increase.

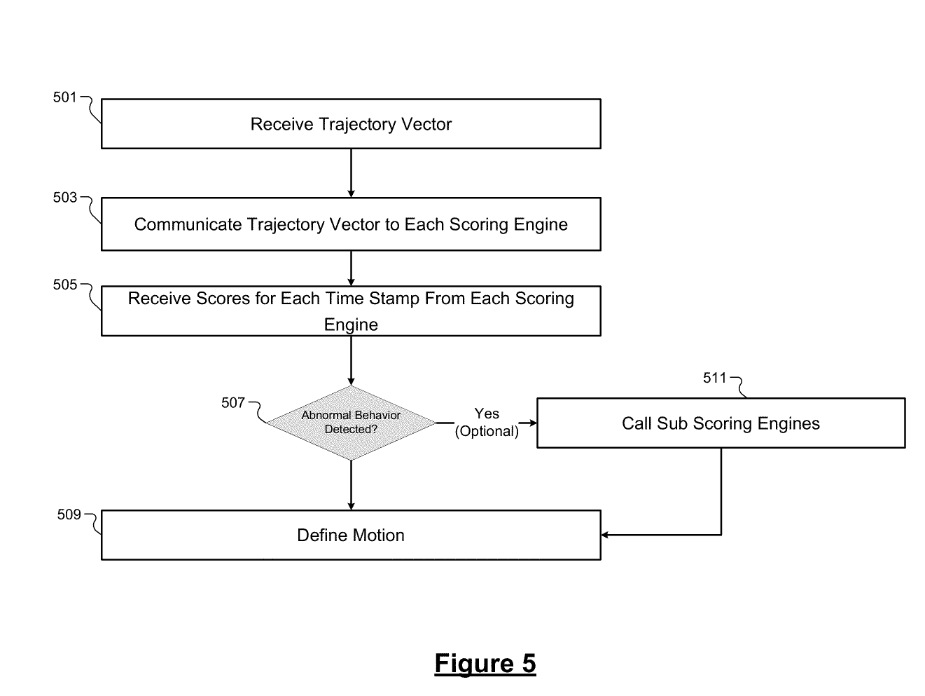

FIG. 5 depicts an exemplary method that may be performed by the abnormal behavior detection module 32. The abnormal behavior detection module 32 receives the observed trajectory vector, as shown at step 501. The observed trajectory vector can include a plurality of undefined fields representing the abnormality score of the trajectory at a particular point in time. Thus, the abnormal behavior detection module 32 communicates the trajectory vector to a plurality of scoring engines, as referenced at step 503. The scoring engines, which are described in greater detail below, will score the trajectory at various points in time and record the score in the appropriate field of the trajectory field.

As can be appreciated, once the trajectory vector has been scored by the scoring engines, the abnormal behavior detection module 32 will receive the scored trajectory vectors, as shown at step 505, and can then determine if any abnormal behavior has been detected. This determination may be achieved by examining each row in the trajectory vector that relates to a scoring engine. For each row, if a consecutive or nearly run of scores have abnormality scores that are greater than a predetermined threshold, then it can be assumed that during the consecutive run, the behavior was abnormal. If abnormal behavior is detected, then the scoring engine may optionally initiate sub scoring engines, as shown at step 511.

Once a trajectory vector is scored by a scoring engine 34 and possibly the sub scoring engines, and abnormal behavior is detected from one or more of the scoring engines 34, the abnormal behavior detection module 32 may classify the trajectory of the motion object based on the abnormality scores, as shown at step 509. Furthermore, the abnormal behavior detection module 32 can be configured to classify separate segments of the trajectory vector based on the abnormality score.

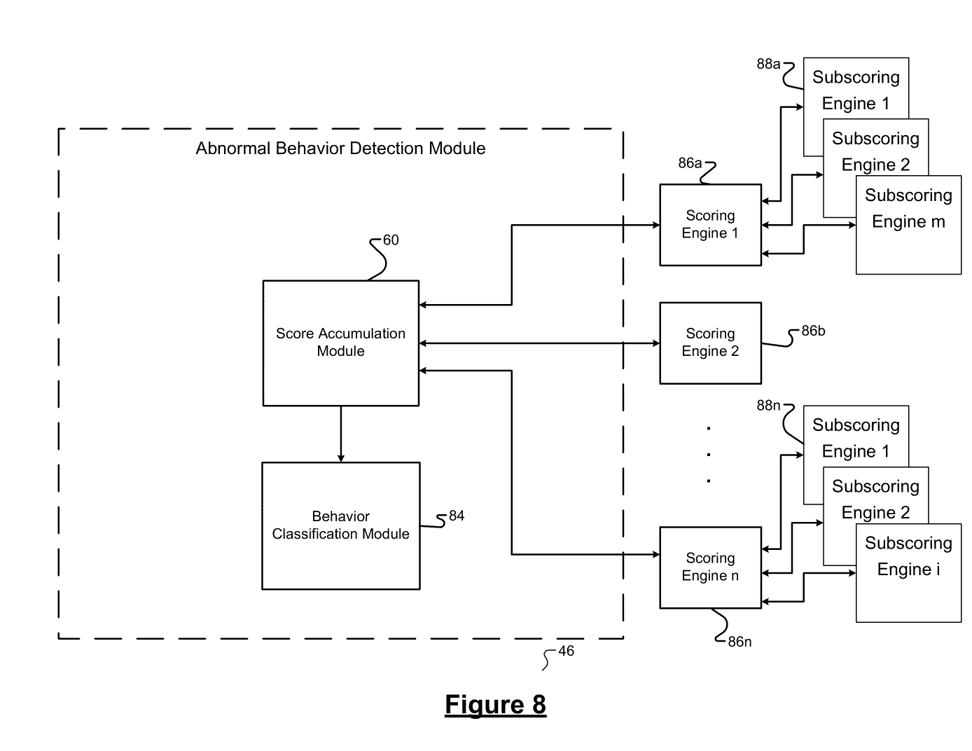

An exemplary abnormal behavior detection module 32 and exemplary scoring engines are now described in greater detail. Once the position, velocity, and acceleration data are calculated, the abnormal behavior detection module 32 receives a trajectory vector from the metadata processing module 30. FIG. 8 illustrates exemplary components of the abnormal behavior detection module 30. The exemplary components of the abnormal behavior detection module include a score accumulation module 82 in communication with a plurality of scoring engines and a behavior classification module 84 that classifies the motion objects behavior based on the accumulated scores. The score accumulation module 82 communicates the trajectory vector to a plurality of scoring engines 86a-n. Each scoring engine is configured to evaluate a trajectory vector in relation to one or more normal motion models defining a particular expected or accepted behavior. The scoring engines will return a score at each time sample indicating a degree of conformity with the one or more models. Thus, a trajectory vector having 16 entries can have 16 scores returned from each scoring engine. It is appreciated, however that not every time entry requires a corresponding score.

The scoring engines 86a-n receive a trajectory vector and score the trajectory by comparing the trajectory to motion models stored in the dynamic model database 44. As discussed, the scoring engines 86a-n may be hierarchical. For example, a speeding scoring engine receives a trajectory and compares the trajectory with one or more models defining “normal” behavior. If speeding is detected in the trajectory, then the trajectory may be communicated to various sub scoring engines, which are all related to detecting different types of speeding. For example, speeding sub scoring engines may include scoring engines configured to detect: burst speeding, constant acceleration speeding, long distance speeding, or any other type of speeding. A wandering sub scoring engine may detect loitering or staying around. An abnormal motion sub scoring engine may detect motion opposite to the traffic flow, motion perpendicular to the traffic flow, zigzag through the traffic flow, or a u-turn in traffic. Various scoring engines have been described in previously submitted applications, including: U.S. application Ser. No. 11/676,127, which is herein incorporated by reference.

To provide context to the reader, an exemplary speeding scoring engine and a burst speeding scoring engine will be described. The speeding scoring engine receives a trajectory vector. For example, a trajectory of { . . . , [t₍ᵢ₋₁₎, x₍ᵢ₋₁₎, yᵢ₍₋₁₎, V₍ᵢ₋₁₎, . . . ], [tᵢ, xᵢ, yᵢ, Vᵢ, . . . ]} may be received. In this example, observations for the same object at times t₍ᵢ₋₁₎ and tᵢ (the current frame and the previous frame) are included in the trajectory data. Furthermore, the trajectory data can include any or all observations starting at t₀, i.e. the first frame where the object is detected. The speeding engine will then retrieve a normal velocity motion model from the dynamic model database 44. While the speeding scoring engine is described using only a single model for a particular behavior, the scoring engine may utilize a plurality of normal velocity motion models. Thus, if the observed trajectory matches with at least one of the models, i.e. has low abnormality scores when compared with a particular normal motion model, then the behavior is normal. If the scores are all abnormal, then the scoring engine can provide scores for the trajectory in a number of ways, e.g. average abnormality score, median abnormality score, highest abnormality score, or lowest abnormality score.

A velocity motion model can contain the expected velocity (μ) or expected velocity components (μₓ) and (μ_{y}) and standard deviations for the expected velocity (σ), or (σₓ) and (σ_{y}). Using the velocity components the raw speeding score at tᵢ may be calculated by:

$$RawSpeedingScore ( i ) = max \{ \frac{( Vx ( i ) - {μ}_{x} )}{σ} , \frac{( Vy ( i ) - {μ}_{y} )}{σ} \} \qquad ( 5 )$$

It is appreciated that the raw speeding score may be further processed by a function that maps the raw speeding score into an interval between [0,1] depending on how far away the score is from k*σ, where k equals 3 for example.

The speeding score of the ith frame can be determined in many ways. One possible method is to determine the median score of a time window. For example, the speeding score of the ith frame may be determined by:

SpeedingScore(i)=median{RawSpeedingScore(i−k−1), . . . ,RawSpeedingScore(i−1),RawspeedingScore(i)} (6)

Again, the foregoing is but one way to determine a speeding score, and other means of determining speeding scores and other types of scores are contemplated.

As the trajectory is analyzed, each time stamp or frame will have a speeding score associated therewith. Once the trajectory is scored by a general scoring engine, e.g. the speeding scoring engine, the scoring engine will examine the scores for the trajectory and determine if the sub scoring engines need to be called. Thus, if the scoring speeding engine detects that a predetermined amount of scores, e.g. 3, are greater than a threshold score then the speeding sub scoring engines are called, including, for example, a burst speeding scoring engine.

An exemplary burst speeding scoring engine can count the number of score values within a time window that are above a burst speeding threshold. For example, for the jth frame, the burst speeding scoring engine will look at the previous m scores, e.g. 5, and determine how many are above the threshold. Next the burst speeding engine calculates a ratio of scores in the window that are over the burst speeding threshold,

BurstSpeedingScore(j)=count/window_size (7)

where count is the amount of scores above the burst speeding threshold in the time window and window_size is the sample size of the burst speeding score, i.e. m. In some embodiments, the burst speeding threshold can be extracted from the score values in the time window by calculating the median of scores and the median of deviations from the median of scores instead of computing a standard deviation and a robust threshold can be define as “median+median of deviations” for easier threshold configuration.

The foregoing description of the speeding engine and the burst speeding engine were provided for exemplary purposes. It is appreciated that other implementations for speeding scoring engines and burst speeding sub scoring engines are contemplated. Further, any type of scoring engines and sub scoring engines can be implemented in the system.

Once the scoring engines return their respective scores and sub scores to the abnormal behavior detection module 32, the abnormal behavior detection module 32 can classify the behavior of the motion object. For instance, if a motion object has three distinct segments having different types of motion, the trajectory may be classified as <Burst Speeding, Wandering, Constant Acceleration Speeding>, which indicates that the motion object first engaged in burst speeding, then it wandered in the FOV of the camera, then it accelerated at a constant acceleration as it exited the FOV of the camera. It is appreciated that the trajectory vector has scores from different scoring engines and sub-scoring engines associated therewith. Thus, the abnormal behavior detection module 32 reads the various scores of the trajectory vector and classifies each segment of the trajectory vector based on the abnormality scores of the particular segment. If a particular segment has a very high speeding score, then that particular segment will be classified as speeding, or a sub classification thereof.

Once the trajectory vector is scored, the abnormal behavior module 32 communicates and the database purging module 38 receives the scored trajectory vector and determines if the trajectory should be included as a motion model in the dynamic model database 44. The database purging module 38 is further configured to adaptively learn the temporal flow patterns of motion objects. The abnormal behavior detection module 36 uses the learned temporal flow patterns to accurately generate abnormal behavior scores, as models corresponding to relevant temporal flow patterns can be generated by the database purging module 38 and stored in the dynamic model database 44.

The database purging module 38 manages the dynamic model database 44 by removing older irrelevant motion models and adding newer relevant models to the dynamic model database 44. As can be appreciated, during the course of the day, many trajectories may be observed and the general traffic flow observed in the FOV of a camera may change. Thus, feature vector database 42 stores feature vectors of recently observed trajectories. The feature vectors are extracted from particular rows of the trajectory vectors of the recently observed trajectories. In other embodiments, the feature vector database 44 may store the actual trajectory vectors of the recently observed trajectories. When a large number of trajectories are observed having similar feature vectors or trajectories, the database purging module 38 may add a new motion model corresponding to those trajectories in the dynamic model database 44 and if a maximum amount of models is reached, the model purging module 38 may replace a less relevant normal motion model with the new motion model. Greater detail on the database purging module 38, the dynamic model database 44 and the feature vector database 42 are provided below.

The dynamic model database 44 contains various normal motion models used by the scoring engines. Thus, in some embodiments, the dynamic model database 44 has specific motion models for each type of scoring engine. For example, the dynamic model database 44 may store three specific models for the speeding scoring engine, three specific models for a wandering scoring engine and three specific models for a traffic flow scoring engine.

Further, the dynamic model base 44 may have an upper limit for the amount of motion models a specific scoring engine can store in the dynamic model database 44. For example, the dynamic model database 44 may be limited to only storing three velocity models for the speeding scoring engine.

Additionally, each model stored in the dynamic model database 44 can include a relevancy score or other indicator of how the particular model compares with the other models. The relevancy score of a model is a value that is a function of both the amount of similar trajectories in the feature vector database 42 and the recentness of those trajectories.

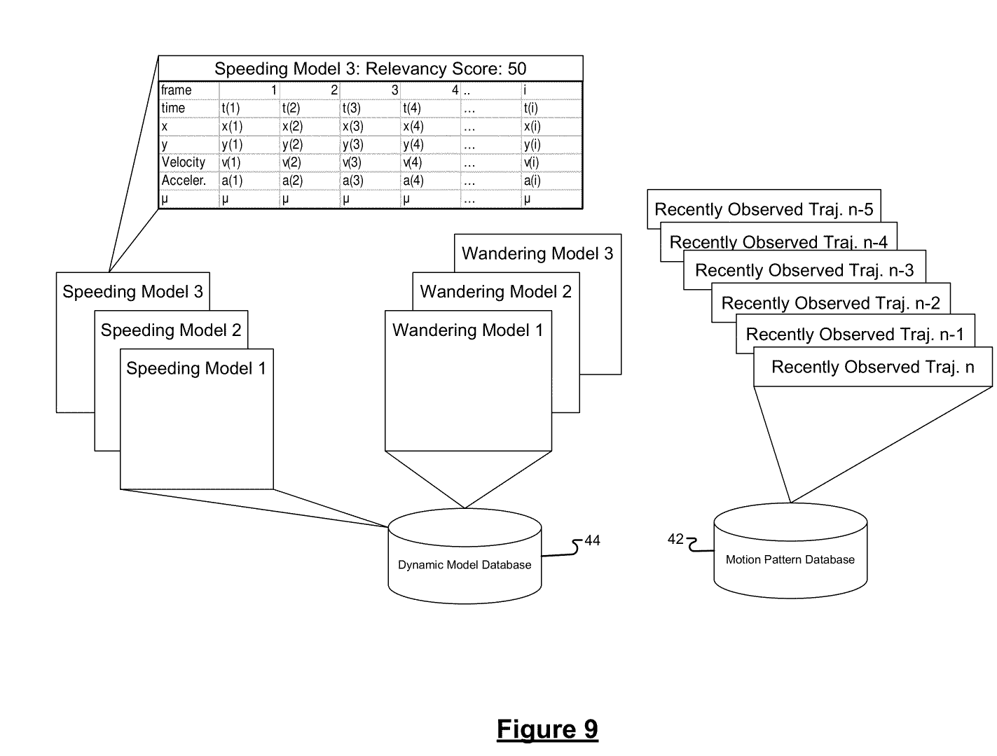

FIG. 9 illustrates an exemplary organization of the dynamic model database 44 and the feature vector database 42. The dynamic model database 44 stores models for the speeding scoring engine and models for the wandering scoring engine. As was discussed, other scoring engines may also have corresponding models stored in the dynamic model database 44. Each model that is stored in the dynamic model database 44, will have the model data 92. In the figure, exemplary model data 92 is shown for speeding model 3. As can be seen, there is also a relevancy score corresponding to the model. As will be discussed below, when a new model is added to the dynamic model database 44, the new model will replace an old model if the maximum amount of models for a particular scoring engine are already stored in the dynamic model database 44. The relevancy scores of the models determines the order in which the database purging module 38 will purge the models from the dynamic model database 44. Furthermore, the dynamic model database 44 also stores time stamps for the most recent trajectories that matched to the model so that the relevancy scores of the models can be updated, as will be discussed below.

Feature vector database 42 stores feature vectors of recently observed trajectories, wherein the features of the feature vectors can correspond to the abnormality score of the trajectory vectors. When a trajectory is scored by the various scoring engines and sub scoring engines, feature extraction may be performed on the score vectors of the trajectory. Furthermore, the starting location of the trajectory and the time of the trajectory may also be included in the feature vector. The feature vectors stored in the feature vector database 42 are used by the database purging module 38 to determine if a normal motion model in the dynamic model database 44 needs to be replaced by a new normal motion model. This would occur when a group or cluster of recently observed trajectories have a relevancy score that is higher than one of the models in the dynamic model database 44.

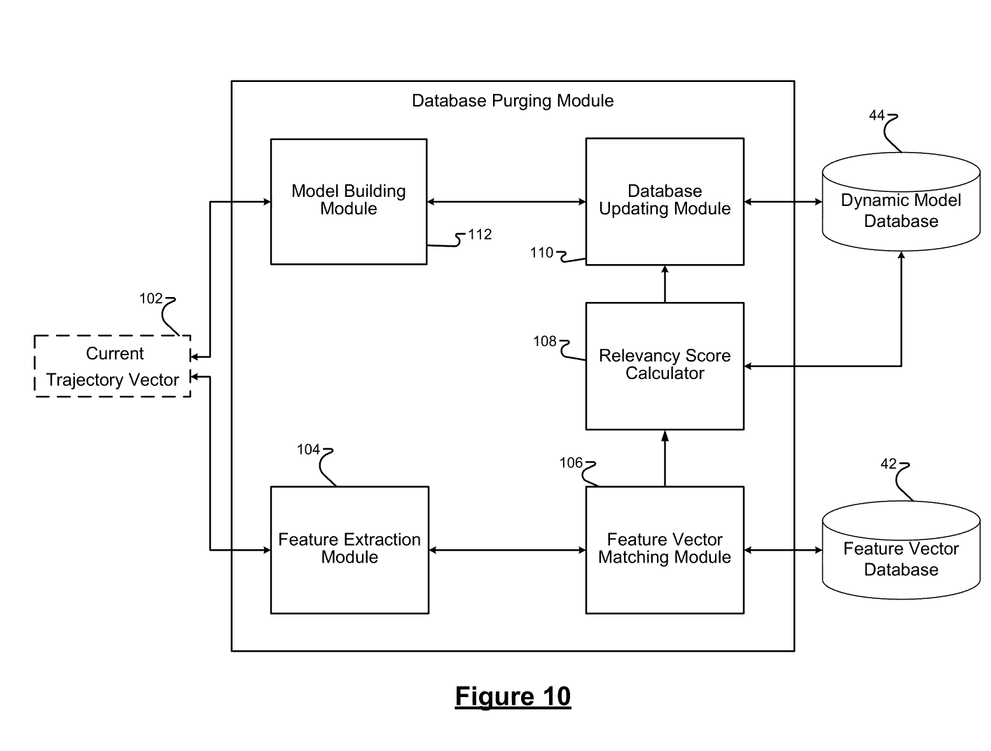

FIG. 10 illustrates components of an exemplary model purging module 38. Model purging module 38 receives a current trajectory vector 102 and determines if a new motion model based on the current trajectory vector should replace one of the motion models in the dynamic model database 44. In particular, a feature extraction module 104 receives the current trajectory and performs feature extraction on the vector. The extracted feature vector is then compared and matched with the feature vectors stored in the feature vector database 42. The feature vector matching module 106 is configured to determine if the feature vector of the current trajectory vector is similar to one or more of the feature vectors of the recently observed trajectories stored in the feature vector database 42. A relevancy score calculator 108 will then calculate a relevancy score of the group of similar feature vectors. A database updating module 110 receives the relevancy score and compares it with the relevancy scores of the models in the database. If so, a model building module 112 will generate a motion model based on the current trajectory vector, which is then stored in the dynamic model database 44. The extracted feature vector is stored in the feature vector database 42.

The feature extraction module 104 receives the current trajectory vector and generates a feature vector by performing feature extraction on the current trajectory vector. In some embodiments, feature extraction is performed on the individual rows corresponding to the scores generated by a particular scoring engine, i.e. the score vectors of the trajectory vector. Thus, if the system has 10 scoring and sub scoring engines, then up to 10 feature vectors can be generated per iteration of the feature extraction module 104. Furthermore, the feature extraction module 104 can associate a starting location and time of the trajectory vector to the feature vector.

It is envisioned that the feature extraction module 104 can be configured to perform many different feature extraction techniques. One technique is to perform Haar transforms on the scores of the current trajectory vector. To perform a Haar transform on a vector, the input vector should have a length the order of 2ⁿ. If a trajectory vector does not have a length of 2ⁿ, it can be lengthened by interpolating additional elements from the various scores in the row or by zero-filling the vector.

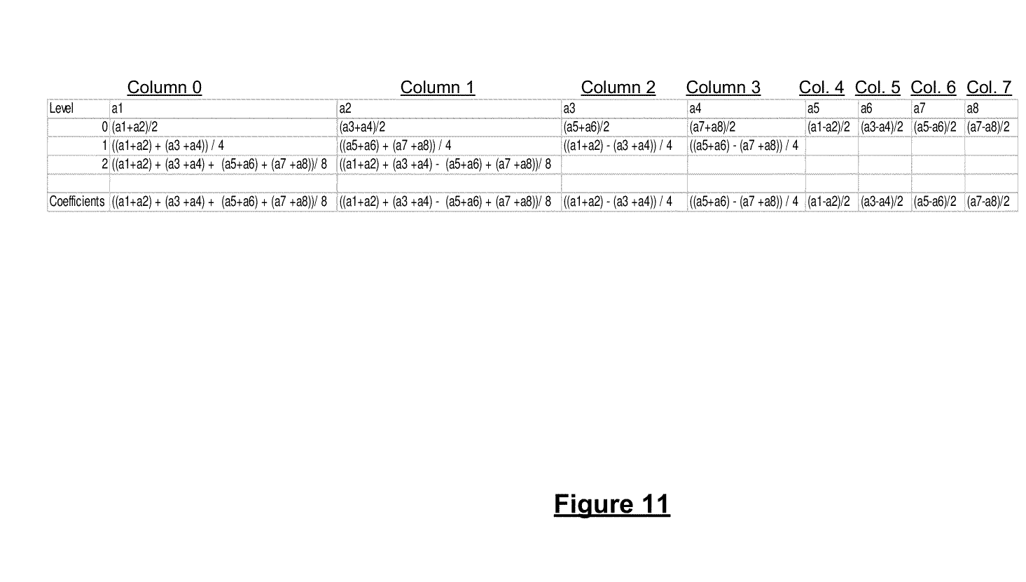

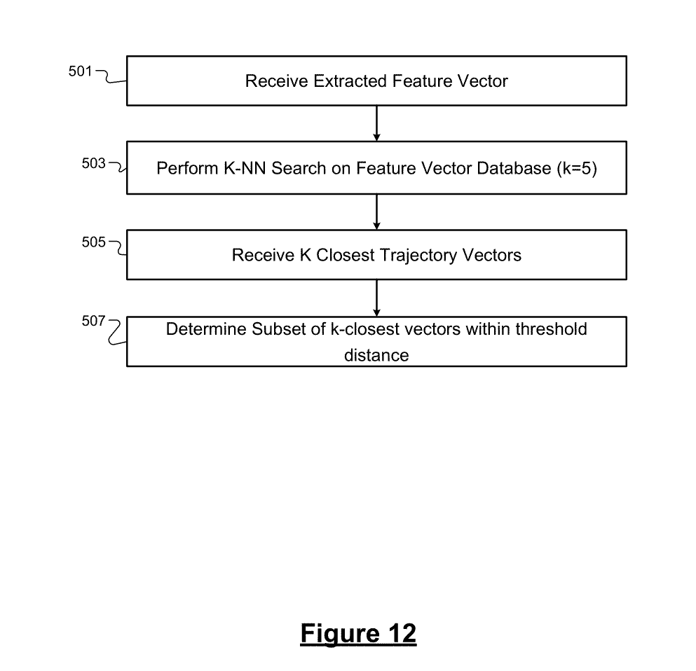

FIG. 11 illustrates an example of a Haar transform. For explanatory purposes, a vector of length 8 or 2³ is depicted. As will become more apparent, when the Haar transform is performed on a vector, the length of the vectors should be of fixed length. The vector in FIG. 11 contains 8 coefficients <a1, a2 . . . , a8>. The Haar transform is performed in three iterations and results in 8 coefficients. The first iteration takes the average of the adjacent elements and the differences between adjacent elements. As can be seen, after the first iteration Col. 1 has the average of A1 and A2 and Col. 2 has the average of A3 and A4, while Col. 5 has (A1−A2)/2 and Col. 6 has (A3−A4)/2. As can be seen from the figure, after the first iteration, the coefficients in Cols. 5-8 of level 0 drop down into the fifth, sixth, seventh, and eighth Haar Coefficients, respectively, at the bottom of the chart. The second iteration calculates the averages of the adjacent elements, but only in Cols. 1-4, and takes the differences between the adjacent elements. For example, after the second iteration, the result in Col. 1 is ((a1+a2)+(a3+a4))/4 and the result in Col. 3 is ((a1+a2)−(a3+a4))/4. After the second iteration, the coefficients in Col. 3 and Col. 4 of level 1 drop down into the third and fourth Haar coefficients at the bottom of the chart. The third iteration is similar to the first and second iterations, but only the coefficients from level 2, Col. 1 and Col. 2 of level 2 are considered. Thus, after the third iteration, the result in Col. 1 is ((a1+a2)+(a3+a4)+(a5+a6)+(a7+a8))/8 and the result in Col. 2 is ((a1+a2)+(a3+a4)−(a5+a6)+(a7+a8))/8. The results of Col. 1 and Col. 2 drop down into the first two Haar Coefficients at the bottom of the chart.

It is appreciated that in some embodiments, the system is configured so that at each motion event, i.e. time stamp, various data and scores may be generated. At each one of these iterations, the feature extraction module 104 receives the updated vector and performs the Haar transform on the updated data. As mentioned, the length of the input vector is 2ⁿ. It can be appreciated that the first few motion events will have trajectory vectors that have lengths that are less than 2ⁿ. For example, if n=3, then the Haar transform receives input vectors of length 8. If, however, a motion object has been detected only 7 times, the trajectory vector will only have length 7. In these situations, the feature extraction module 104 interpolates the remaining scores of the trajectory prior to performing the Haar transforms, e.g. the 8^{th} data sample may be interpolated based on the previous 7 scores. It is envisioned that any interpolation techniques may be used.

Furthermore, once the length of the trajectory vector exceeds the input length for the Haar transform function, then feature extraction module 104 can use a sliding window that looks back at the previous 2ⁿ entries in the trajectory vector. Thus, in the example where the Haar transform is performed on vectors of length 8, after the ninth sample is received and scored, the Haar transform function may receive an input vector having the second through the ninth score instances of the trajectory vector. After the tenth, the Haar transform function would receive the third through the tenth score.

Once the Haar transform is performed on an input vector, the feature extraction module performs coefficient selection from the Haar coefficients. It is appreciated that the leftmost coefficients, e.g. coefficients 1-4, are lower frequency components of the score vectors and the rightmost coefficients, e.g. 5-8, are higher frequency components of the frequency vector. Thus, in the example provided above, the feature extraction module 104 selects the first four coefficients. It is envisioned, however, that other coefficients may be selected as well. Furthermore, if the Haar transform function receives longer vectors, i.e. 16 or 32 scores, then more coefficients may be selected.

While the foregoing has been described with respect to a single score vector, it is appreciated that the Haar transforms may be performed on some or all of the score vectors of a trajectory vector. For example, at each iteration a Haar transform may be performed on the scores generated from the speeding scoring engine, the wandering scoring engine, the traffic flow scoring engine, and one or more of the respective sub scoring engines.

Once feature extraction is performed, the feature vector matching module 106 matches the extracted feature vector with the feature vectors of previously scored trajectory vectors in the feature vector database 42. The feature matching module 106 determines if there is one or more feature vectors in the feature vector database that are similar to the extracted feature vector.

One possible way to identify similar feature vectors is to perform a k-nearest neighbor (K-NN) search on the feature vector database 42. The k-nearest neighbor search algorithm receives the extracted feature vector as an input and searches the feature vector database 42 for and returns the k-closest feature vectors. It is appreciated that a measure of similarity, such as a distance, is used to determine “closeness.” The k-nearest neighbor search will determine the distance between the extracted feature vector and all of the previously extracted feature vectors in the feature vector database 42. The k-nearest neighbor search will then return the k-closest feature vectors and may also return the distance from each of the extracted feature vectors. While the returned distance in some embodiments is the Euclidean distance between the extracted feature vector and the selected feature vector, it is envisioned that other distance measurements may also be used. The feature vector matching module 106 can then determine if any of the k-returned vectors are within a threshold distance from the extracted feature vectors. The subset of feature vectors within the threshold distance from the extracted feature vectors can then be communicated to the relevancy score calculator.

While a K-NN search algorithm is contemplated, it is understood that other algorithms may be used to identify similar trajectories. For example, a k-means clustering algorithm may be used. In such embodiments, a distance between the extracted feature vector and the feature vectors in the same cluster can be calculated. Those vectors within the threshold distance from the extracted feature vector may be included in the subset described above.

Once the subset of vectors within the threshold distance from the extracted feature vector has been identified, the relevancy score calculator 108 can determine the relevancy score of the subset of feature vectors and the extracted feature vector. The relevancy score calculator also updates the score of a model in the dynamic model database 44 when a trajectory is scored as “normal,” by a scoring engine. For example, when a trajectory is scored as normal, the relevancy calculator will calculate a new relevancy score for the model using the new trajectory and the k-most recent trajectories. Furthermore, so that the relevancy score of each model is current, the relevancy score calculator may also update the scores of the models at each iteration of the database purging module 38. As will be discussed, the relevancy score is dependent on the passage of time. Thus, the relevancy score of each model should be updated so that the relevancy score accurately represents the relevancy of the model as time passes.

As mentioned, the relevancy score is a measure of how relevant a subset of feature vectors are in comparison to a model in the model database, or vice-versa. In some embodiments, the relevancy score is a function of the amount of feature vectors in the subset of vectors and the recency of those feature vectors, or the recency of the previous k trajectories that a scoring engine matched to the model whose relevancy score is being calculated.

The relevancy score function can be implemented in a number of ways. Essentially, the function gives greater weight to trajectories that are more recent than to those that are less recent. One possible way is to calculate a recentness score and a density score of a model. The recentness score can be calculated by calculating the following:

$$\begin{matrix}Δ {T}_{model ( i )} = {T}_{model ( i )} - {T}_{old} & ( 8 ) \\ Δ {T}_{curr\_span} = {T}_{curr} - {T}_{old} & ( 9 ) \\ {RS}_{model ( i )} = \frac{Δ {T}_{model ( i )}}{Δ {T}_{curr\_span}} & ( 10 )\end{matrix}$$

where T_{model(i)} is the time at which the model was last used, T_{curr} is the current time, and T_{old} is the time at which the model that was least recently used was last used. It is understood that the recentness score can be expressed by another type of function, such as a exponential decay function or a sigmoid function.

The density score can be calculated by using the following:

$${DS}_{model ( i )} = \frac{{D}_{model ( i )} ( i )}{{D}_{max}} \qquad ( 11 )$$

where D_{model(i)} is the number of feature vectors in the feature vector database 42 that matched to the last trajectory to match to model(i), and where Dₘₐₓ=k, where k is the number used to perform the k-nearest neighbor search.

Based on these two scores, the relevancy score can be calculated according to:

Relevancy_Score_{model(i)}=w₁RS_{model(i)}=w₂DS_{model(i)} (12)

Where the weights w1 and w2 are the weights given to each score.

The relevancy score of an observed trajectory can be scored using equation 12, where the recent score is 1, and the density score is the number of feature vectors that matched to that of the observed trajectory divided by k.

Database updating module 110 receives the calculated relevancy score from the relevancy score calculator 108. In the instance where a trajectory matched to a model in the dynamic model database, database updating module 110 will simply update the relevancy score of the model, as calculated by the relevancy score calculator 108. In the instance where the current trajectory was determined to be abnormal, the relevancy score of the current trajectory and the subset of the closest vectors will be compared with the relevancy scores of the models in the dynamic model database 44. If the computed relevancy score is higher than one or more of the models in the dynamic model database 44, then the database updating module 110 will replace the model having the lowest relevancy score with a new model, which is generated by model building module 112. In the case of a tie, the model that was least recently used can be purged or the model with the least amount of matching feature vectors can be removed.

Moreover, if the dynamic model database 44 does not contain the maximum amount of models for a particular scoring engine, then the new model may be entered into the database without replacing a preexisting model. To ensure that a model of abnormal behavior is not included in the dynamic model database 44, the database updating module 110 may require that the relevancy score of the subset exceed a predetermined threshold prior to storing the new model in the dynamic model database 44.

An exemplary model building module 112 receives the current trajectory 102 and generates a motion model to be stored in the dynamic model database 44. The model building module 112 also receives a type of model to generate. For example, a model to be used for a speeding scoring engine, then model building module 112 will generate a model having data specific to the speeding scoring engine. It is appreciated that model building is dependent on the configurations of the scoring engines and the operation thereof. Examples of model building may be found in U.S. Patent Publication Number 2008/0201116. Once the model building module 112 generates a new model, the new model is communicated to database updating module 110, which then stores the new model in the dynamic model database 44.

In another aspect of the disclosure, the surveillance system can be configured to clean the data by removing outliers and smoothing the data. In these embodiments the metadata processing module 30 may further include a data cleansing module and a Haar filter. The following provides alternative means for processing metadata and is not intended to be limiting.

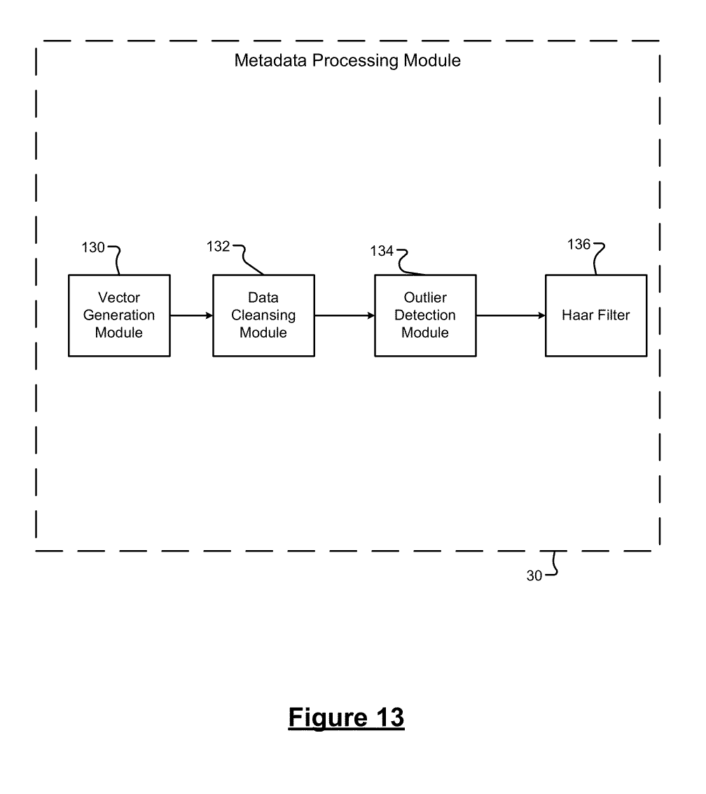

FIG. 13 includes an alternative embodiment of the metadata processing module 30. It is envisioned that the alternative embodiment of the metadata processing module 30 may be used interchangeably with metadata processing module 30 described above. In the alternative embodiments, the metadata processing module 30 comprises a vector generation module 130, a data cleansing module 132, an outlier detection module 134, and a Haar filter 136. The data cleansing module 132 is configured to detect abnormal position data that is received from metadata generation module 28 and is further configured to label the abnormity of the position data. The data cleansing module 132 filters burst noises in the position data based on the 1) normal behavior statistics recorded in a motion velocity map or 2) previous motion measurements of the same trajectory. A motion velocity map is a slice of a data cube, where the “width” of the slice corresponds to an amount of time. The level of deviation to the normal distribution of the normal behavior statistics is defined as a sigma level of outlier, i.e. level*σ, where σ is the standard deviation. It is also considered as a confidence level of an outlier being detected. For testing and validation purpose, the statistics of the number of outliers of different sigma are summarized for analysis purposes. For performance optimization, a pre-filter is used to filter out the normal points in the motion data. A sigma level for each data point is calculated for each point in the trajectory vector. The sigma level can be used for filtering and scoring operations in order to discount or adjust the confidence level of a score. The data cleansing module 132 can save processed position data into a metadata position buffer.

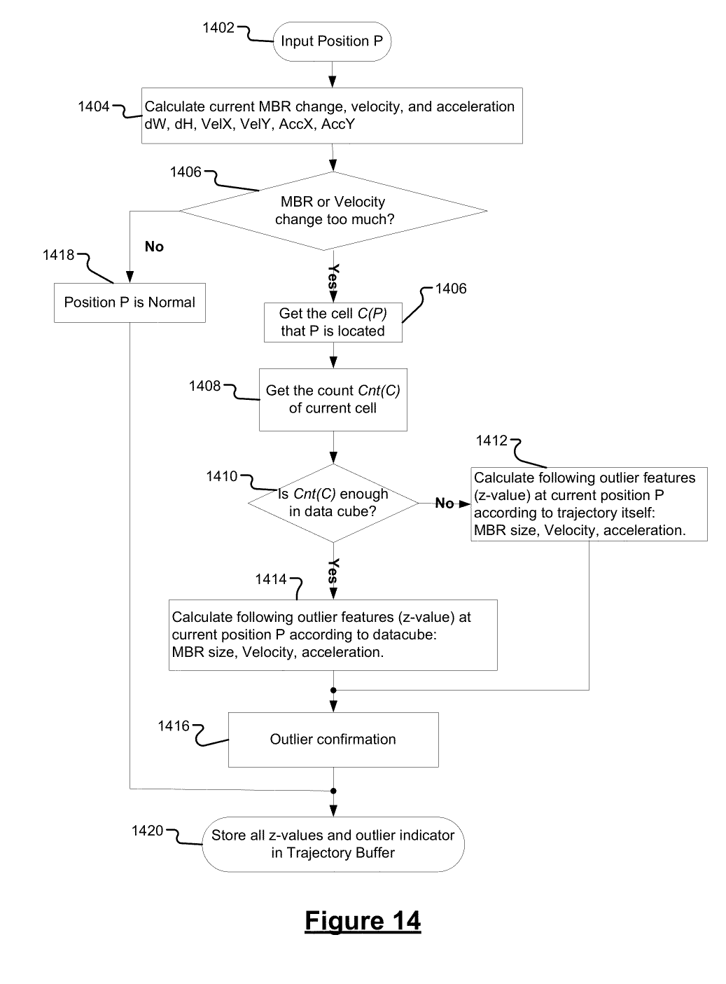

In the alternative embodiments the metadata processing module 30 also includes an outlier detection module 134. FIG. 14 illustrates an exemplary method that may be used to perform outlier detection. In this particular embodiment, it is assumed that the minimum bounding box size (height and width), velocity in both the x and y direction, and acceleration in both the x and y direction in a data cube follow a Gaussian distribution. Thus, any position of a trajectory is determined to be an outlier if one of the 6 above mentioned variable has a value that is too far from the average value, e.g. 6 sigmas.

As can be seen in the figure, a trajectory for a motion object is received at step 1402. The outlier detection module 134 will first calculate the change of the size of the bounding box, the velocity and accelerations for a trajectory, as shown at step 1404. If none of the changes are too large, then the trajectory is determined to be normal and the method steps 1420. If however, one of the changes is too extreme the method steps to step 1406 where the data cube for a particular cell is retrieved. The amount of motion objects observed in the cell is counted at step 1408 and compared with a predetermined threshold at step 1410. If there is not enough data in the cell, then the features of the trajectory will be calculated, as shown at step 1412. In this case, the simple average from the positions of the trajectory are used to calculate z-values, which is computed according to the following:

$$z = \frac{\vert x - μ \vert}{σ}$$

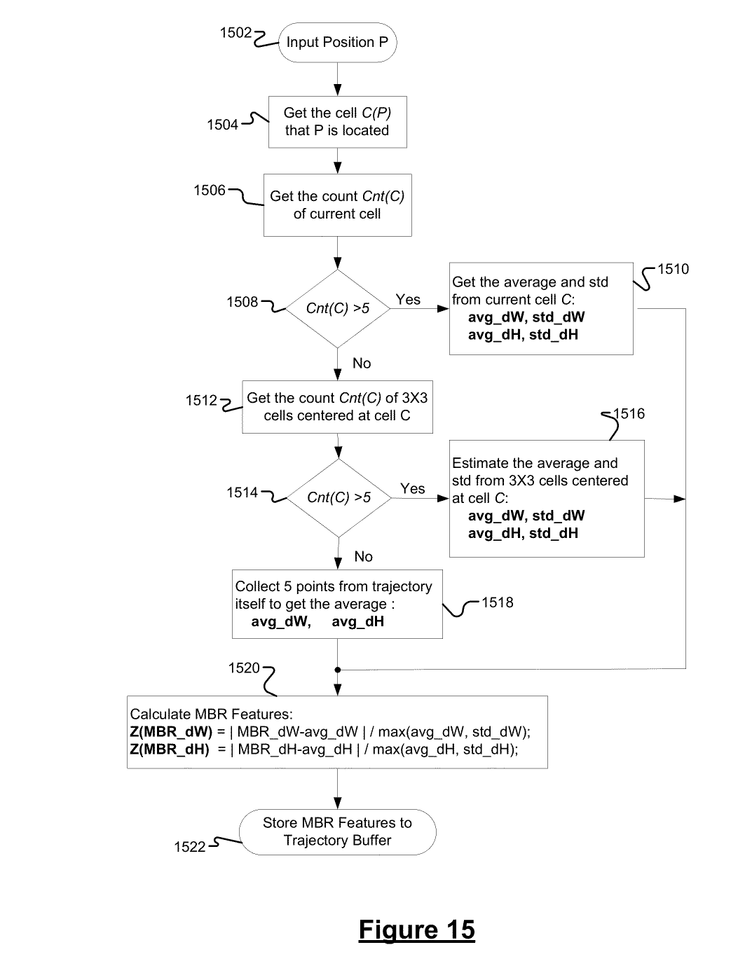

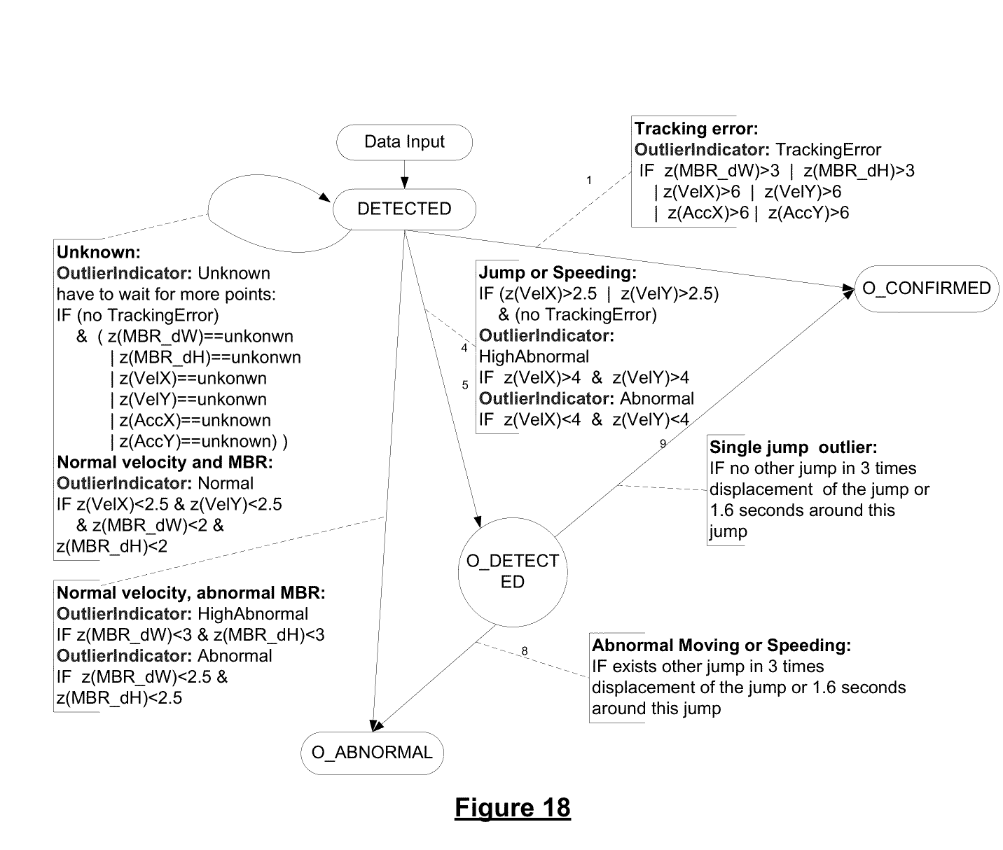

If there is enough data in the data cube, then the features will calculate for the data cube itself, as shown at 1414. FIGS. 15-17 illustrate exemplary methods to calculate outlier features for a particular type of data in a data cube. At step 1416 outlier confirmation is performed. The outlier confirmation determines if a position is an outlier according to the 6 determined outlier features, i.e. the z values of the 6 features. The state diagram depicted in FIG. 18 can be used to perform outlier confirmation by categorizing the outlier features. Table I, shown below, provides categorizations for the various outlier features. It is appreciated that when a tracking error or a jump happens in the data, the position will be labeled as an outlier.

| Variable | Normal | Abnormal | HighAbnormal | TrackingError |
|---|---|---|---|---|
| Z(MBR_dW) | <2.0 | (2.0, 2.5) | (2.5, 3.0) | >3.0 |
| Z(MBR_dH) | <2.0 | (2.0, 2.5) | (2.5, 3.0) | >3.0 |
| Z(VELX) | <2.5 | (2.5, 4.0) | (4.0, 6.0) | >6.0 |
| Z(VELY) | <2.5 | (2.5, 4.0) | (4.0, 6.0) | >6.0 |
| Z(ACCX) | <2.5 | (2.5, 4.0) | (4.0, 6.0) | >6.0 |
| Z(ACCY) | <2.5 | (2.5, 4.0) | (4.0, 6.0) | >6.0 |

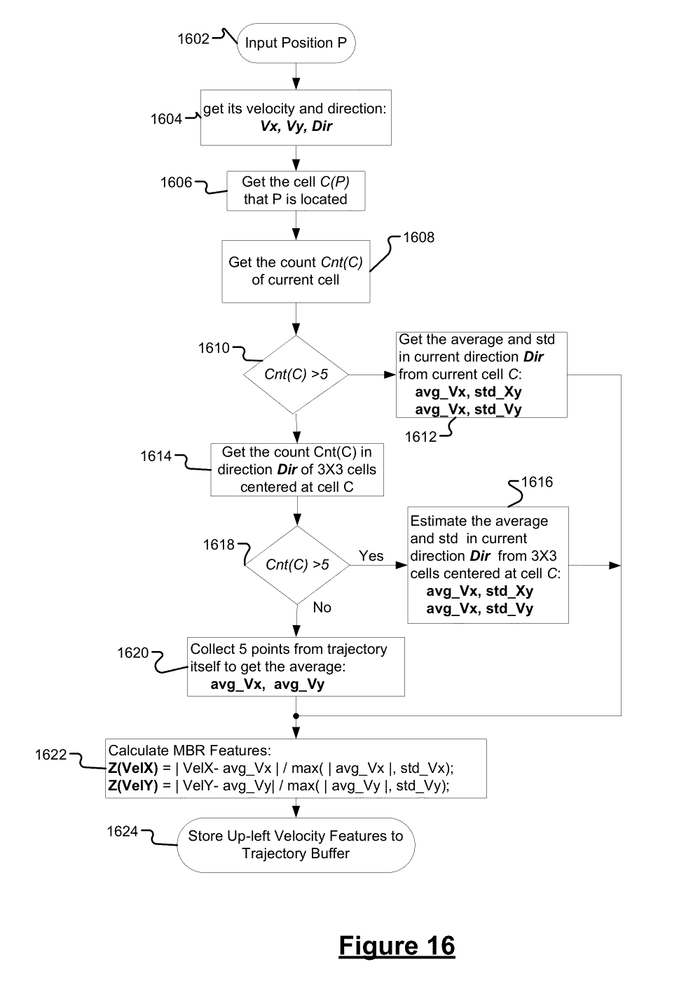

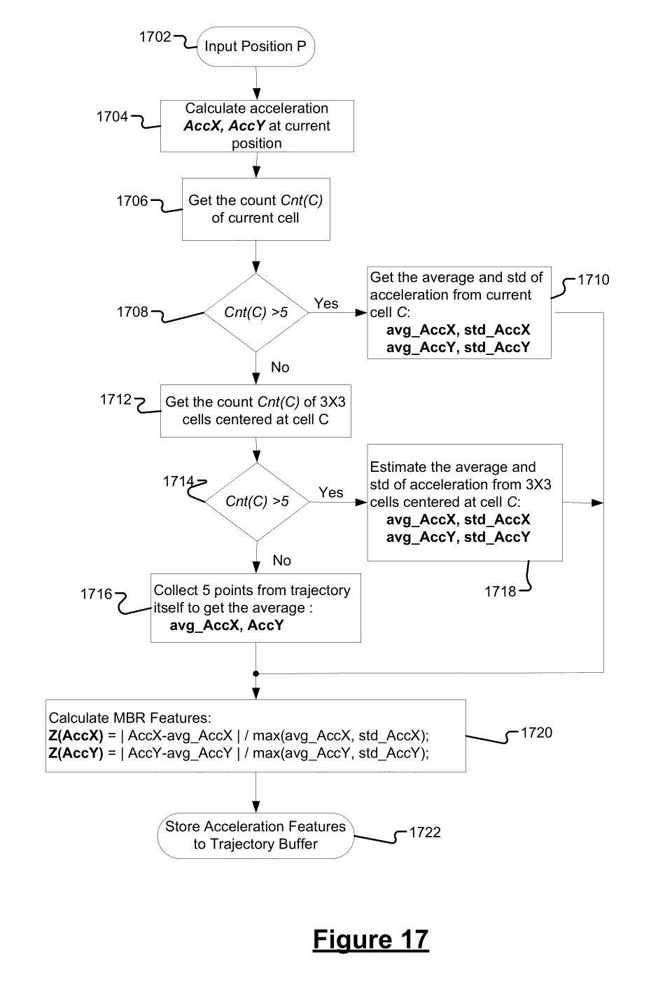

As mentioned, if there is enough data in the data cube, then the features will calculate for the data cube itself. FIGS. 15-17 illustrate methods for determining the features of a data cube. FIGS. 15-17 all contain substantially the same steps, so the description of FIG. 15 can be used to understand FIGS. 16 and 17.

A position of an object in a trajectory is received at step 1502. The data cube corresponding to the position is retrieved at step 1504 and the count of the data cube, i.e. how many trajectories have passed through the cell over a given period of time, is retrieved at step 1506. If the count is greater than a predetermined threshold, e.g. 5, then the method steps to 1510, where the average and standard deviation of the heights and widths of the bounding boxes observed in the cell are calculated. If, however, the count for the cell is less then the predetermined threshold, then the data cubes of the eight neighboring cells are retrieved at step 1512. If the count of the cell and the eight neighboring cells is greater than the predetermined threshold, the average and standard deviation of the bounding boxes observed in those nine cells is calculated or estimated, as shown at step 1516. If the count for the nine cells is less than five, however, then the average and standard deviation of the height and width of the bounding box as observed in the trajectory is calculated at step 1518.

At step 1520 a z score for the height and width of the bounding boxes is calculated based on the averages and standard deviations that were determined at one of steps 1510, 1516 and 1518. The z-score of the data, i.e. the height and width of the bounding box of the currently observed motion object, can be calculated using the following:

$$z ( BB\_H ) = \frac{\vert BB\_H - Avg\_H \vert}{max ( AVG\_H , std\_dev \_H )}$$

$$z ( BB\_W ) = \frac{\vert BB\_W - Avg\_W \vert}{max ( AVG\_W , std\_dev \_W )}$$

Where z(BB_H) is the z-value of the height of the currently observed bounding box and z(BB_W) is the z-value of the width of the currently observed bounding box. Once calculated, the z-values are stored for confirmation.

It is appreciated that the z-scores of the observed velocities and trajectories can be calculated according to the methods shown in FIGS. 16 and 17, which substantially correspond to FIG. 15. Calculating the z-scores of the velocity and the acceleration may further require the calculation of the current velocity and acceleration of the motion object if outlier detection is performed prior to these values being calculated.

Also included in the alternative embodiment of the metadata processing module 30 is a filter 136. It is envisioned that the filter may be a Kalman filter, a Haar filter, or any other type of data filter. For explanatory purposes, a Haar filter 136 is assumed.

The Haar filter 136 provides the adaptive trajectory filtering to reduce the impact of non-linear noise in the motion data caused by tracking errors. To optimize the design for performance and code base reduction, the Haar filter 136 is configured to perform a simple Haar transform on the motion data. The Haar filter 136 may have at least one of the following properties:
1. Produces more accurate velocity and acceleration values in the trajectory vectors using multiple sample points to reduce random white noise;
2. Uses more data points to calculate macro level motion based on the outlier confidence sigma measure when bursty outliers are detected in the motion data;
3. Has log N complexity and is only involved in binary shift operation;
4. The estimated point generated by the Haar filter 136 is based on weighted sum of predicted point and the measurement point from input weighted by a function of outlier sigma;
5. Produces smooth and shape preserving outputs; and
6. Reduces the number of points needed to represent the motion, velocity, and acceleration for each trajectory.
   It is appreciated that the Haar filter 136 operates on the data from metadata position buffer and can output filtered and smooth data into the metadata position buffer.

The outlier detection module 134 communicates the outlier magnitude to Haar filter 136 to control the Haar transformation depth in outlier situation. The Haar filter 136 can estimate one level D coefficients and by performing an inverse Haar transformation, the Haar filter 136 can output smoothed lower-level S coefficients. The estimated D coefficients are used in velocity and acceleration estimation. S coefficients are the low frequency coefficients in a Haar transform and D coefficients are the high frequency coefficients. The S coefficients generally relate to the averaging portion of the Haar transform, while the D coefficients generally relate to the differencing portion of the Haar transform.

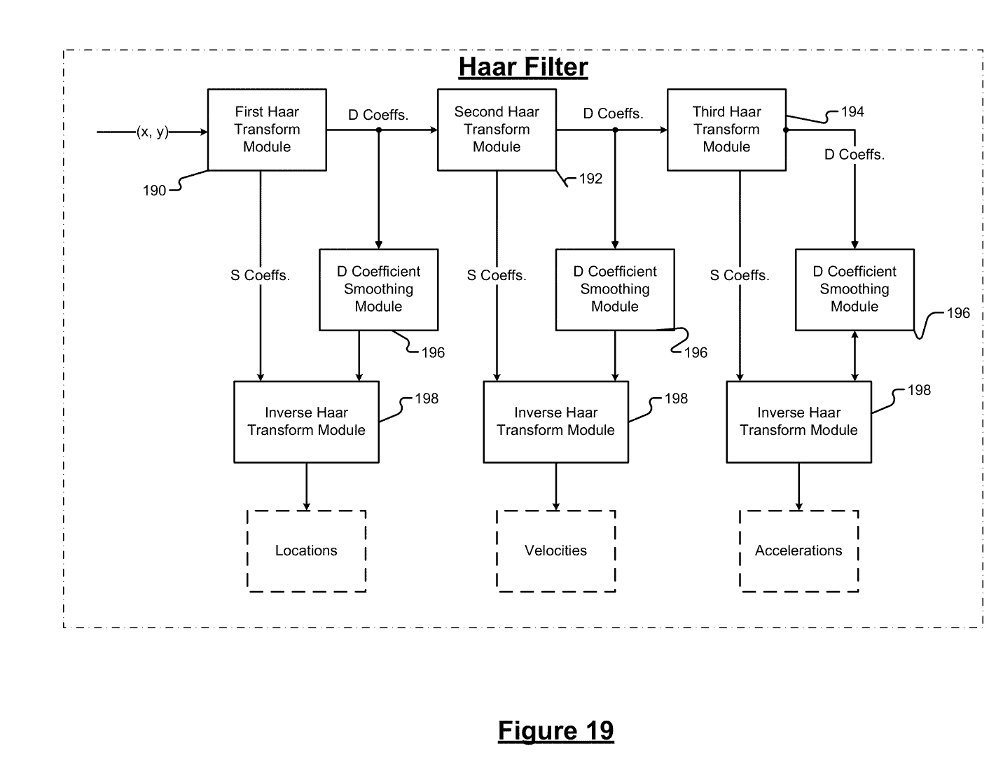

FIG. 19 shows an exemplary Haar filter. The Haar filter comprises a first Haar transform module 190, a second Haar transform module 192, a third Haar transform module 194, a D coefficient smoothing module 196 (shown thrice), and a inverse Haar transform module 198 (shown thrice). The output of the inverse Haar transform module 198 when receiving the S coefficients of the first Haar transform module 190 and the first set of smoothed D coefficients produces the location estimates of the trajectory. The output of the inverse Haar transform module 198 when receiving the S coefficients of the second Haar transform module 192 and the second set of smoothed D coefficients produces the velocities of the trajectory. The output of the inverse Haar transform module 198 when receiving the S coefficients of the third Haar transform module 194 and the third set of smoothed D coefficients produces the accelerations of the trajectory.

It is appreciated that the Haar transformation modules 190-194 perform a Haar transformation in a similar manner to the Haar transformation discussed above, with respect to FIG. 11. The caveat is that each successive Haar transform module only receives the D coefficients of the previous Haar transform. Thus, the size of the input vector is reduced by a factor of two in each successive Haar transform module. For example, if the first Haar transform module receives a 32 entry vector, the second Haar transform module 192 will receive a 16 entry vector, and the third Haar transform module 194 will receive an 8 entry vector.

The outputs of the first Haar transform module 190 are the S coefficients, which are communicated to the inverse Haar transform module 198, and the D coefficients which are communicated to the second Haar transform module and the D coefficient smoothing module. It is appreciated that the D coefficients outputted by the first Haar transform module 190 represent the x and y components of the velocities of the input trajectory.

The outputs of the second Haar transform module 192 are the S coefficients, which are communicated to the inverse Haar transform module 198, and the D coefficients, which are communicated to the third Haar transform module and the D coefficient smoothing module 196. It is appreciated that the D coefficients outputted by the second Haar transform module 192 represent the x and y components of the accelerations of the input trajectory.

The outputs of the third Haar transform module 194 are the S coefficients, which are communicated to the inverse Haar transform module 198, and the D coefficients, which are communicated the D coefficient smoothing module 196. It is appreciated that the D coefficients outputted by the second Haar transform module 194 represent the x and y components of the change of the accelerations of the input trajectory.

As can be seen from the figure, the D coefficients are also communicated to the D coefficient smoothing module 196. After the D coefficients are smoothed then the S coefficients and the smoothed D coefficients are communicated to the inverse Haar transform module 198. The inverse Haar transform module 198 performs the inverse of the Haar transform to reconstruct the input vector. As can be appreciated the result of the inverse Haar transform module will correspond to the input fed into the respective Haar transform module 190-194 but will be performed on the resulting S coefficients and the smoothed D coefficients. Thus, the inverse Haar transform of the S coefficients from the first Haar transform module 190 and the corresponding smoothed D coefficients represent the locations of the trajectory. The inverse Haar transform of the S coefficients from the second Haar transform module 192 and the corresponding smoothed D coefficients represent the velocities of the trajectory. The inverse Haar transform of the S coefficients from the third Haar transform module 194 and the corresponding smoothed D coefficients represent the accelerations of the trajectory. The output of the Haar filter 136 is the motion data of the trajectory vector.

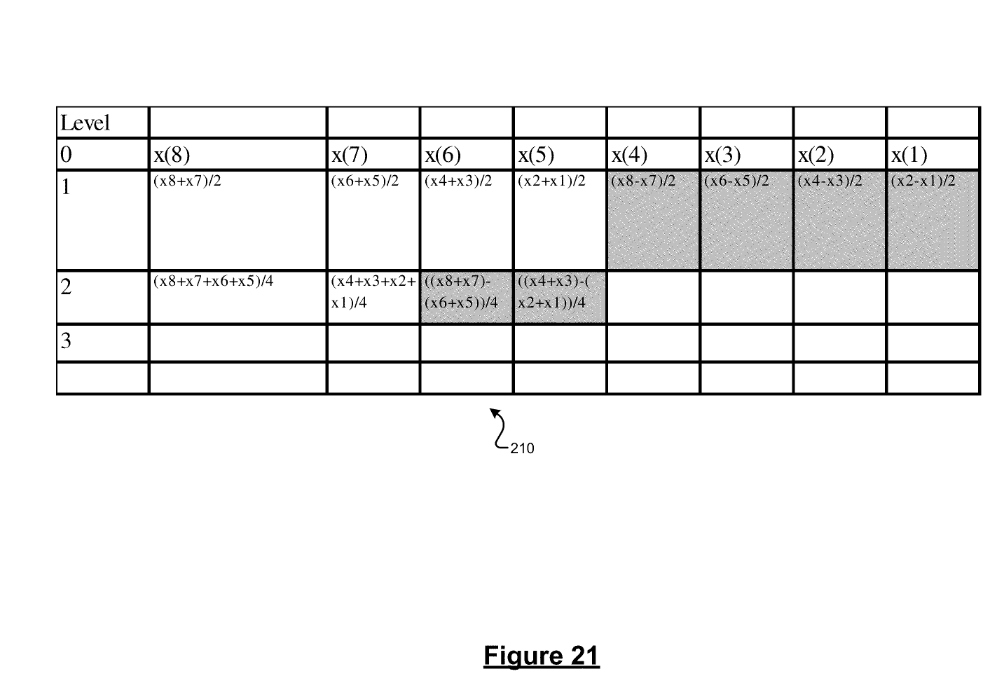

The D smoothing module 196 is configured to receive the D coefficients from a Haar transform and performs D smoothing on the coefficients. The D smoothing module 196 is described in reference to FIG. 21. FIG. 21 illustrates various levels of a Haar transform 210. As can be appreciated from the Figure, the level 3 coefficients are not shown, as those coefficients are not required to perform D smoothing. The shaded portions of the figure represent the D coefficients. For purposes of explanation, the D coefficients are referenced by D(level, position), such that

$$D ( 1 , 0 ) = ( \frac{x ( 8 ) - x ( 7 )}{2} ) , D ( 1 , 1 ) = ( \frac{x ( 6 ) - x ( 5 )}{2} )$$

$$D ( 2 , 0 ) = ( \frac{( x ( 8 ) + x ( 7 ) ) - ( x ( 6 ) + x ( 5 ) )}{4} ) ,$$

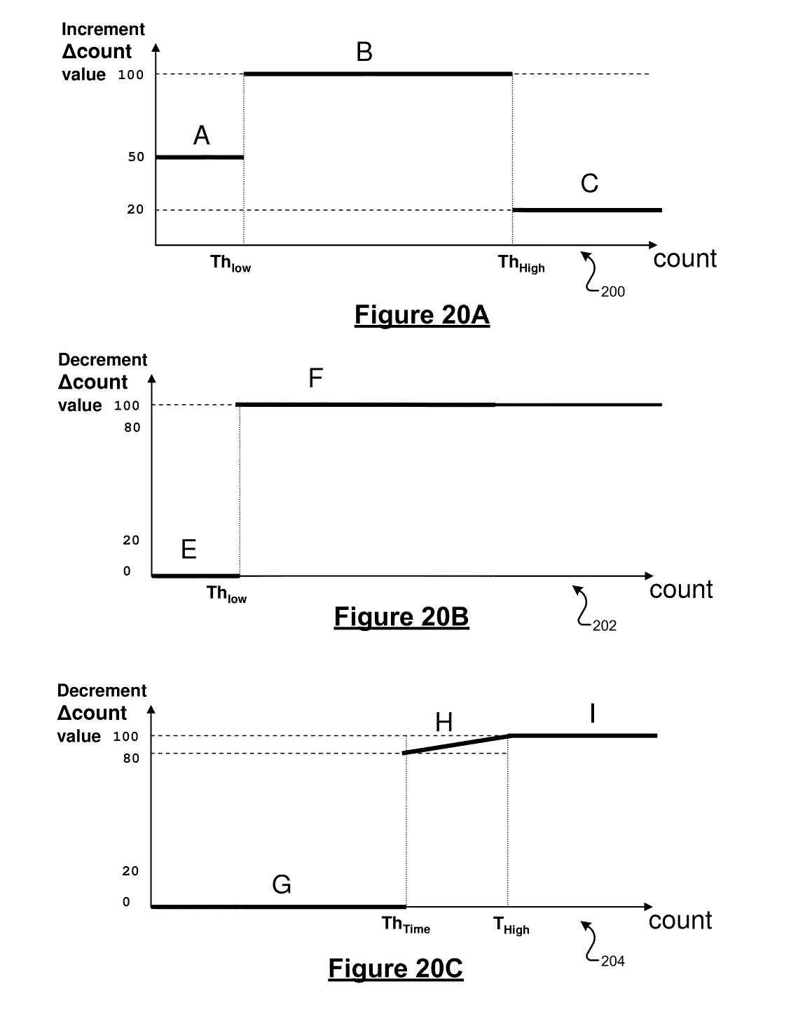

etc. Using the Haar transform of FIG. 20 as reference, the D coefficients can be smoothed using the following:

D(1,0)·X=(D(2,0)·X*W₁)/2+D(1,0)·X*W₂

D(1,1)·X=(D(2,0)·X*W₁)/2+D(1,1)·X*W₂

D(1,2)·X=(D(2,1)·X*W₁)/2+D(1,2)·X*W₂

D(1,3)·X=(D(2,1)·X*W₁)/2+D(1,3)·X*W₂

D(1,0)·Y=(D(2,0)·Y*W₁)/2+D(1,0)·Y*W₂

D(1,1)·Y=(D(2,0)·Y*W₁)/2+D(1,1)·Y*W₂

D(1,2)·Y=(D(2,1)·Y*W₁)/2+D(1,2)·Y*W₂

D(1,3)·Y=(D(2,1)·Y*W₁)/2+D(1,3)·Y*W₂

where W₁ and W₂ are predetermined weights. In some embodiments, W₁ is set to ¼ and W₂ is set to ¾. The result of the smoothing is the smoothed D coefficients which are communicated to the inverse Haar transform module 198. It is appreciated that the foregoing frame work can be applied to larger or smaller sets of D coefficients.

The inverse Haar transform module 198 receives S coefficients and D coefficients and performs an inverse Haar transformation on said coefficients. As can be seen from FIG. 11, the coefficients of the Haar transform are derived from different levels. The inverse Haar transform begins at the lower level coefficients, i.e. the S and D coefficients and iteratively solves for the coefficients of the previous levels, such that the original low level coefficients can be solved for from the successive higher level coefficients. For example, referring to FIG. 11, the inverse Haar transform module 198 can use the values of the coefficients in columns 0 and 1 to solve for the values of the level 2 coefficients. It is appreciated in this iteration of the example, the value of ((a1+a2)+(a3+a4)) and the value of ((a5+a6)+(a7+a8)) can be solved for knowing that ((a1+a2)+(a3+a4)+(a5+a6)+(a7+a8))/8 is the expression used to obtain the value of the coefficient of column 0 and (((a1+a2)+(a3+a4))−((a5+a6)+(a7+a8)))/8 is the expression used to obtain the value of the coefficient in column 1. It is appreciated that this logic is used to solve for the level 1 values, using the values of level 2 and the coefficients of columns 2 and 3. The same logic can be applied to solve for the level 0 values using the level 1 values and the coefficients from columns 4-7. Finally, the original elements can be solved for using the level 0 values. The output of the inverse Haar transform module 198 will correspond to the input of the Haar transform module 190-194 providing the coefficients, but may differ therefrom due to the D coefficient smoothing.

The outputted trajectory of the Haar filter 136 preserves the shape, velocity, and direction of the original trajectory in the image plane. The time interval of the trajectory is preserved in each point.

For a motion object that moves slowly in the far FOV such that the accuracy of position is not sufficient to detect the velocity accurately, the Haar filter 136 uses multiple points to generate a low resolution estimation of the trajectory points to reduce the computational overhead. The outputted down-sampled points are bounded in time and space. In the time domain, the Haar filter 136 outputs minimal trajectory points in a range from a minimal time default to a maximum time default, e.g. 1.6 seconds. In the space domain, the Haar filter 136 outputs observation in either the x or y direction for a default value of a cell distance of the size, e.g. 16 pixels. The output decision is based on the time and space thresholds. If the object is not moving the time thresholds ensure that there is a minimal rate for output. If an object is moving, the space threshold ensures that the output is always produced when the displacement of the object is considerable.

The outlier smoothing can be the outlier detection indicators from the data cleansing module 132 as input to decide the range of points needed to calculate estimated trajectory points. Estimating or interpolating trajectory points achieves higher level of accuracy by smoothing out the effects of large jumps in the trajectory. In order to perform smoothing, the Haar filter 136 will estimate the D coefficients of some level from higher level D coefficients and then perform a Haar inverse transform to get better estimates of lower-level S or D coefficients. Generally, the outlier smoothing process can include two operations: D coefficients smoothing and Haar Inverse Transformation.

The Haar filter 136 can predict the incoming points of a trajectory based on internal Haar coefficients. For example, an upcoming x coordinate in a trajectory can be predicted by:

Xₚ(i,Δt)=X(L,i−1)+V(L,i−1)*Δt

Where X(L,i−1) is the previous Haar S coefficient, and V(L,i−1) is the previous Haar D coefficient, and Δt is a change in time. L is the level in the Haar pyramid. An example of a Haar pyramid is shown in FIG. 11. A Haar pyramid includes the coefficients as well as the intermediate levels of the Haar transform. In order to reduce the computation load, suitable estimation of the Haar transformation depth can be implemented based on the magnitude of the outlier detection, i.e. the z-value. When the outlier magnitude is higher, the Haar transformation depth is deeper. The prediction can also use non-linear curve fitting techniques. For example, using interpolation the following can be used to predict the Xₚ (i):

fₕ(t)=Curve_fitting(X(0,i−1),X(1,i−1)X(2,i−2))

here fₓ(t), for example, is a polynomial function,

$${\sum }_{i = 0}^{n} {a}_{i} {t}^{i} ,$$

and X₍ₚ₎(i)=fₓ(tᵢ) where

$$X ( 0 , i - 1 ) = X ( {t}_{( i - 1 )} ) , at t = {t}_{( i - 1 )}$$

$$X ( 1 , i - 1 ) = ( \frac{x ( {t}_{( i - 1 )} ) + x ( {t}_{( i - 2 )} )}{2} ) , at t = ( \frac{{t}_{( i - 1 )} + {t}_{( i - 2 )}}{2} ) and$$

$$X ( 2 , i - 1 ) = ( \frac{x ( {t}_{( i - 1 )} ) + x ( {t}_{( i - 2 )} ) + x ( {t}_{( i - 3 )} ) + x ( {t}_{( i - 4 )} )}{4} ) , \\ at t = ( \frac{{t}_{( i - 1 )} + {t}_{( i - 2 )} + {t}_{( i - 3 )} + {t}_{( i - 4 )}}{4} )$$

where X(0,i−1), X(1,i−1), X(2,i−1) are the level-0, level-1, and level-2 Haar coefficients. For example, suppose the incoming point the coordinates are at X(i), Z would then be the value of X speeding and W is the adaptive weighting factor. The function mapping of the Z value to W weighting factor is listed as shown in table 1.

TABLE 1

| Z | L(Level of prediction) | W |
|---|---|---|
| 0 | 0 | 1 |
| 1 | 0 | 1 |
| 2 | 0 | 1 |
| 3 | 0 | 1 |
| 3 < z < 6 | Floor(4z/3-4) | 2-z/3 or exp (3-z) |
| >=6 | 4 | 0 |

X(i)=Xₚ(i)(1−W)+Xₘ(i)W

where X(i) is the final input for the Haar transformation pyramid. The following is an alternative W calculation table:

| Z-Value | W |
|---|---|
| Z < 1 | 1 |
| 1 <= Z < 2 | 0.5 |
| 2 <= Z < 3 | 0.125 |
| 3 <= Z < 4 | 0.06 |
| 4 <= Z < 5 | 0.03 |
| 5 <= Z < 6 | 0.01 |
| 6 <= Z | 0 |

The Haar filter 136 may be further configured to implement a Haar transformation sliding window, which records all the Haar pyramid nodes. This window can be implemented by an array or another data structure type. In a situation where the Haar filter 136 receives a 32 element vector, the highest level will be 5. Each node in the pyramid can be accessed by a level index and a position index, e.g. indices (level, pos). The level index is 0 to 4. Because it is a sliding window, the position varies from 0 to an upper bound. For example, for level 0, pos varies from 0 to 16. Once pos passes 16, it resets to 0. The most current index of each level is saved into a second array.

The structure of the Haar window is implemented by a one-dimensional array. In some embodiments, only the last two nodes of each level are saved in the array. The index of the array is mapped to the Haar pyramid according to the following table 2.

TABLE 2

| | | |
|---|---|---|
| Level 0 | 0 | 1 |
| Level1 | 2 | 3 |
| Level2 | 4 | 5 |
| Level3 | 6 | 7 |
| Level4 | 8 | 9 |

By structuring the Haar pyramid in this fashion, a point in the Haar pyramid can be accessed by specifying a level and position. In the table provided above, there is five levels, where level 4 is the highest and the positions from each level vary from 0 to 1. For reference, the terms D(level, pos) will be used to stand for a D coefficient at a specific level and position, and S(level, pos) will be used to stand for an S coefficient at a specific level and position.

The two points resulting from an Inverse Haar transformation of node (level, pos) are:

$$\begin{matrix}\begin{matrix}S ( level \text{-} 1 , {2}^{*} pos ) \cdot x = S ( level , pos ) \cdot x + D ( level , pos ) \cdot x , pos = 0 , 1 , 2 , … \\ S ( level \text{-} 1 , {2}^{*} pos ) \cdot y = S ( level , pos ) \cdot y + D ( level , pos ) \cdot y , pos = 0 , 1 , 2 , … \\ … \\ S ( level \text{-} 1 , {2}^{*} pos + 1 ) \cdot x = S ( level , pos ) \cdot x + D ( level , pos ) \cdot x , pos = 0 , 1 , 2 , … \\ S ( level \text{-} 1 , {2}^{*} pos + 1 ) \cdot y = S ( level , pos ) \cdot y + D ( level , pos ) \cdot y , pos = 0 , 1 , 2 , … \\ …\end{matrix} & \end{matrix}$$

If no D and S coefficients are changed from a previous level, the Inverse Haar transformation from higher level node should output the exact same results as the S coefficients in the lower level nodes. But if one or more high level D coefficients are changed, after performing and inverse Haar transformation, the lower level S coefficients are also changed.
All the above operations can be performed by a recursive function The function performs an n-th level Haar transformation, smoothing, and inverse Haar transformation based on two lower level S coefficients pos1 and pos2. The pseudo code for the above described is shown in Table 3:

```
TABLE 3
1. Get curpos1 <= S(level,pos), dcurpos1 <= D(level,pos).
2. Advance pos in current level by 1, turn around when necessary.
3. Perform two-point Haar Transformation to update the node (level,pos)
based on pos1 and pos2.
4. If level+1 is greater than transformation depth, return.
5. If pos is odd number
  5.1 curpos2<=S(level,pos), dcurpos2 <= D(level,pos).
  5.2 invoke FirstHaarUpdate for next level from curpos1 and
curpos2
  5.3 performing smoothing to dcurpos1 and dcurpos2
  5.4 performing two-point inverse haar to update curpos1 and curpos2
  End
```

There are five situations where the Haar filter 136 can output metadata to the metadata buffer based on different criteria. The different criteria include: the initial point output, the down-sampling output for slow moving objects, interpolation output for very fast moving objects, long delay forced output for even slow moving objects, and trajectory end output

When the initial point of one trajectory is not the first point in the metadata buffer, it may be the 2-level Haar transformed points of the first 4 points in the metadata buffer. However, if the trajectory is very slow, all the first 4 points are inside one cell. Thus, the direction of the first 4 points is unlikely to be accurate. Therefore, the initial point is output when the slow moving object moves out of one cell.

Once all the smoothed Haar coefficients are obtained, the down-sampling procedure can be performed to pick nodes from the smoothed nodes. Down-sampling is used to reduce total sample number. The pseudo code the down-sampling procedure is shown in table 4 below:

```
TABLE 4
1. Get last output node in the meta data buffer if it is valid
2. Search latest points in the Haar window buffer from lowest level to
  highest level to see if the distance to the last output node is large than
  cell size, if larger, continue to higher level, otherwise exit
3. find the two adjacent level where lower level is larger than cell size and
  higher level is smaller than cell size, output the higher cell Haar point
  and advance the outLastPosID index
```

If the Haar filter 136 detects there are long jumps (larger than one cell in size) between adjacent original points in the metadata buffer, the Haar filter 136 will interpolate several points in between the jumping points to make sure the trajectory can cover all the cells the motion object passed with proper time stamps.

If the Haar filter 136 does not output anything for a period greater than a predetermined amount of time, e.g. over 1.6 seconds, it means the motion object is likely very slow. The distance from last output points is less than one cell dimension. However, in order to keep real-time requirement the Haar filter 136 needs to output a point even though the points is not far from previous output point.

When a trajectory is finished, new points may also be outputted into the metadata buffer, the Haar filter needs to process those points and output metadata at the end of the trajectory.

As mentioned above, the Haar filter 136 can be further configured to determine the velocity and the acceleration of a motion object. The velocity can be calculated using the speed of two adjacent outputted points:

Velocity_{—}x=(CurPos·x−PrePos·x)/(CurPos·time−PrePos·time)

Velocity_{—}y=(CurPos·x−PrePos·x)/(CurPos·time−PrePos·time)

For the down-sampled node (level, pos), the local velocity of the node is just the corresponding higher level D coefficients divided by time duration, e.g.:

Velocity(level,pos)·x=D(level+1,pos/2)·x/D(level+1,pos/2)·time

Velocity(level,pos)·y=D(level+1,pos/2)·y/D(level+1,pos/2)·time

pos=0,1,2, . . .
In addition, the Haar filter 136 can refer to the S coefficients in the second Haar transformation, where the velocity in different resolutions is listed. After a second Haar transformation, the accelerations are listed as the D coefficients. It is envisioned that the trajectory vector may be calculated with these velocities and accelerations.

In another aspect of the disclosure the database purging module 38 is configured to further include a fading module (not shown). The fading module is configured to adaptively learn the temporal flow of motion objects with respect to each cell. The model building module 112 can use the learned temporal flow patterns to generate motion models used to score abnormal behavior. As described above, each cell can have a data cube associated therewith, where the data cube stores a time-series of motion data from motion objects passing through the cell. Included in the stored motion data are the directions of the motion objects observed passing through the cell. Referring back to the cell depicted in FIG. 7, the direction of a motion object can be defined by associating the direction to one of the octants. The fading module can be configured to update a count for each octant in a cell. Thus, each octant will have its own count associated therewith, whereby a direction most observed in the cell, hereinafter referred to as the “dominant flow” of the cell, can be determined by comparing the counts of each octant in the cell.

The fading module can keep track of the dominant flow of the cell using an asymmetric function that retains a minimal direction count for each octant. The count of an octant of a cell can be incremented or decremented in two different situations. One situation is a detection based situation and the other is time based situation. A detection based situation is when a motion object is detected in the cell. In these instances the octant corresponding to the direction of the motion object will have its count incremented and the other seven octants will have their counts decremented. In the time based situation, no object has been detected in a cell for more than a predetermined amount of time. In this situation the counts of the cells will be decremented.

In both instances the amount that a count of an octant gets incremented or decremented is dependant on the value of the octant's count. For example, if a count of an octant is to be incremented, the amount by which the count is incremented is determined by a function that receives the value of the count as input and that outputs the amount to increment the count by.

For purposes of explanation, three thresholds are defined, and will be discussed below. The three thresholds are Th_{Low}, Th_{Time}, and Th_{High}. Furthermore, there is a counter for the entire cell, which is Cell·xy·mem_cnt.

FIGS. 20A and 20B illustrate the amount to increment and decrement, respectively, the count of an octant based on the value of the particular octants count. For example, referring to the graph 200 of FIG. 20A, if the count of an octant to be incremented is below Th_{low}, then the count is incremented by the value corresponding to section A, e.g. 50. If the count of the octant to be incremented is greater than Th_{low} but less than or equal to Th_{High}, then the count is incremented according to section B, e.g. 100. If the count of the octant to be incremented is greater than Th_{High}, then the count is incremented according to section C, e.g. 20. Thus, when the fading module determines that a motion object has passed through a particular cell in the direction of a particular octant, the fading module will determine the amount to increment the particular octant's count by using the function depicted in graph 200. It is understood that the numbers provided are exemplary and not intended to be limiting. Further, while a step function is shown, the various sections may be defined by other types of functions, such as linear, quadratic, exponential, logarithmic, etc.

Referring now to FIG. 20B, the graph 202 illustrates the amount that the count of an octant is decremented by in a detection situation. If the count of an octant is less then Th_{low}. If the count of an octant is greater than Th_{Low}, then the count of the octant to be decremented is decremented by the value corresponding to section F, e.g. 100. Thus, when the fading module determines that a motion object has passed through a particular cell in the direction of a particular octant, the fading module will determine the amount to decrement each of the counts of the other octants using the function depicted in graph 200. It is appreciated that other function types besides a step function may be used to define the amount that the count will be decremented by.

Referring now to FIG. 20C, the graph 204 illustrates an the amount that the count of an octant is decremented by in a time based situation. It is appreciated that in a time based situation, an object has not been detected for more than a predetermined amount of time. In these instances, no octant will be incremented. In the time based situation, an octant having a count that is less than T_{Time} is not decremented. An octant having a count that is greater than T_{Time} but is less than Th_{High}, will be incremented by an amount corresponding to section H. As can be appreciated, section G in this example is defined by a linear function, thus depending on the actual count of the octant, the amount to be decremented will vary. Finally, if the count of an octant is higher than Th_{High}, the count will be decremented according to section I, e.g. 100. Thus, when the fading module determines that a motion object has not passed through a particular cell for more than a predetermined amount of time, the fading module will determine the amounts to decrement each of the counts of the octants using the function depicted in graph 204. The graph in FIG. 20C is provided for an example of one possible decrementing scheme. It is envisioned that other functions may define the various sections of graph 204.

Additionally, with respect to FIGS. 20A-20C, whenever the count of any octant is incremented the total count of the cell, e.g. Cell·xy·mem_cnt is incremented by the same amount. Further, whenever the count of any octant is decremented the total count of the cell is decremented by the same amount.

It is envisioned that in some embodiments, the fading module may increment the counts of an octant by a predetermined amount, e.g. 1, when an object is detected moving through the cell in the direction corresponding to the octant and decrement the count of the other octants by the same predetermined amount. Similarly, the counts of all the octants may be decremented by the predetermined amount when an object has not been observed in the cell for more than a predetermined amount of time.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A surveillance system having a surveillance processing circuit that receives metadata of image data, the surveillance processing circuit comprising:
a metadata processing circuit that receives metadata and determines an observed trajectory of a motion object in the image data;
a scoring engine processing circuit that scores the observed trajectory and returns a score;
an abnormal behavior detection processing circuit that analyzes the score to determine if abnormal behavior has been observed; and
an alarm generation processing circuit issuing an alarm event according to the determination of the abnormal behavior detection processing circuit.

2. The surveillance system of claim 1, further comprising a metadata generation processing circuit generating said metadata of the image data, the surveillance processing circuit receiving the metadata.

3. The surveillance system of claim 1, wherein the image data is divided, using a processing circuit, into a plurality of cells such that metadata for a time-series of a particular cell is adapted to be formatted into a data cube; and
wherein the metadata processing circuit confirms an outlier using the data cube and determines the observed trajectory of the motion object in the image data.

4. The surveillance system of claim 3, further comprising an outlier detection processing circuit confirming an outlier using outlier features for a particular type of data in said data cube.

5. The surveillance system of claim 4, wherein the type of data in said data cube is at least one of: bounding box width, bounding box height, x velocity, y velocity, x acceleration and y acceleration.

6. The surveillance system of 1, further comprising a dynamic model database storing a new normal motion model, and a database purging processing circuit managing the dynamic model database;
wherein the scoring engine processing circuit receives the observed trajectory and scores the trajectory by comparing the trajectory to the new motion model stored in the dynamic model database; and
wherein the database purging processing circuit adds the new motion model to the dynamic model database.

7. A method for processing image data in a surveillance system, comprising:
using a processing circuit to receive metadata associated with said image data and to determine an observed trajectory of a motion object in said image data;
using a scoring engine processing circuit to score the observed trajectory and return a score;
using a processing circuit to analyze the score to determine if abnormal behavior has been observed; and
using a processing circuit to issue an alarm event according to the determination if abnormal behavior has been observed.

8. The method claim of claim 7, further comprising using a processing circuit to generate said metadata associated with said image data.

9. The method of claim 7, further comprising using a processing circuit to divide the image data into a plurality of cells where metadata for a time-series of a particular cell is adapted to be formatted into a data cube; and
using a processing circuit to confirm an outlier using the data cube and to determine the observed trajectory of the motion object in said image data.

10. A computer program product comprising a non-transitory computer-readable medium having a computer-readable program code embodied therein, said computer-readable program code adapted to be executed by a processor to implement a surveillance method operating on image data, said method comprising:
receiving metadata associated with said image data and determining an observed trajectory of a motion object in said image data;
scoring the observed trajectory to return a score;
analyzing the score to determine if abnormal behavior has been observed; and
issuing an alarm event according to the determination if abnormal behavior has been observed.

11. The computer program product of claim 10, wherein the computer-readable program code is further adapted to be executed by a processor to generate said metadata associated with said image data.

12. The computer program product of claim 10, wherein the computer-readable program code is further adapted to be executed by a processor:
to divide the image data into a plurality of cells where metadata for a time-series of a particular cell is adapted to be formatted into a data cube; and
to confirm an outlier using the data cube and to determine the observed trajectory of the motion object in said image data.
